(19) United States
(12) Patent Application Publication
(10) Pub. No.: US 2026/0013436 A1
(43) Pub. Date: Jan. 15, 2026

(54) AGRICULTURAL OPERATION MONITORING SYSTEMS AND METHODS

(71) Applicant: Deere & Company, Moline, IL (US)

(72) Inventors: Nathan R. VANDIKE, Geneseo, IL (US); Martin F. UNTERPAINTNER, Saarbrücken (DE); Mehul P. BHAVSAR, Pune (IN); Pallavi BHARGAVA, Dhar (IN)

(21) Appl. No.: 19/231,074

(22) Filed: Jun. 6, 2025

Related U.S. Application Data
(60) Provisional application No. 63/670,422, filed on Jul. 12, 2024.

(51) Int. Cl. A01D 41/127

(52) U.S. Cl. CPC A01D 41/1276; A01D 41/1277

(57) ABSTRACT

An agricultural system includes an imaging device configured to capture an image indicative of a characteristic, one or more processors, and memory storing instructions executable by the one or more processors. The instructions, when executed by the one or more processors, cause the agricultural system to: determine, based, at least, on the image, a probability value corresponding to the image, the probability value indicating a probability that the characteristic indicated by the image corresponds to a characteristic level category of a plurality of characteristic level categories; and control an agricultural machine based, at least, on the probability value.

### CROSS-REFERENCE TO RELATED APPLICATION

The present application is based on and claims the benefit of U.S. Provisional Patent Application Ser. No. 63/670,422 filed, Jul. 12, 2024, the content of which is hereby incorporated by reference in its entirety.

### FIELD OF THE DESCRIPTION

The present description relates to agricultural work machine operations. More specifically, the present description relates to agricultural work machine operations, monitoring characteristics relative to the agricultural work machine operation, and controlling an agricultural work machine.

### BACKGROUND

There are a wide variety of different types of agricultural work machines. One such example agricultural work machine is an agricultural harvester (also called harvester) that performs, as an agricultural work machine operation, harvesting in which the harvester is used to harvest various crops, such as different types of grain crops, at a worksite (e.g., field). A harvester can include, among other things, residue monitoring systems to capture images of crop residue generated by the harvester and used to adjust a subsequent worksite operation based upon analysis of the images.

The discussion above is merely provided for general background information and is not intended to be used as an aid in determining the scope of the claimed subject matter.

### SUMMARY

An agricultural system includes an imaging device configured to capture an image indicative of a characteristic, one or more processors, and memory storing instructions executable by the one or more processors. The instructions, when executed by the one or more processors, cause the agricultural system to: determine, based, at least, on the image, a probability value corresponding to the image, the probability value indicating a probability that the characteristic indicated by the image corresponds to a characteristic level category of a plurality of characteristic level categories; and control an agricultural machine based, at least, on the probability value.

One or more techniques and systems are described herein for crop harvest monitoring. In one implementation, a crop harvest monitoring system comprises an imaging device configured to acquire a plurality of images of a crop harvest. The crop harvest monitoring system further comprises an analyzing unit configured to categorize the plurality of images based on an analysis of one or more crop harvest characteristics of the crop harvest in the plurality of images by determining a probability of a crop harvest characteristic level corresponding to each of the plurality of images. The crop harvest monitoring system also comprises a control unit configured to generate a control signal to adjust a crop harvesting operation based at least in part on the determined probabilities.

In another implementation, a computerized method for crop harvest monitoring comprises acquiring a plurality of images of a crop harvest characteristic and processing the plurality of images to (i) categorize the plurality of images based on an analysis of one or more crop harvest characteristics in the plurality of images by determining a probability of a crop harvest characteristic level corresponding to each of the plurality of images. The computerized method further comprises generating a control signal to adjust a crop harvesting operation based at least in part on the determined probabilities.

In another implementation a harvester vehicle comprises a harvester configured to harvest a grain crop and produce a crop harvest and an imaging device coupled to the harvester and configured to acquire a plurality of images of a crop harvest characteristic. The harvester vehicle further comprises an analyzing unit configured to categorize the plurality of images based on an analysis of one or more crop harvest characteristics in the plurality of images by determining a probability of a crop harvest characteristic level corresponding to each of the plurality of images. The harvester vehicle also comprises a control unit configured to generate a control signal to adjust a crop harvesting operation of the harvester based at least in part on the determined probabilities.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram illustrating a crop harvest characteristic monitoring system according to an implementation.

FIG. 2 is a graph of probability plots generated according to an implementation.

FIG. 3 is a graph of a plot of category outputs based on an average of probabilities over time generated according to an implementation.

FIG. 4 is an example of a method for managing field operations according to an implementation.

FIG. 5 is a diagram illustrating a camera mounting arrangement for a crop residue monitoring system according to an implementation.

FIG. 6 is a diagram of a user interface according to an implementation.

FIG. 7 is a partial pictorial, partial schematic illustration showing an example harvester.

FIG. 8 is a block diagram of one example crop harvest characteristic monitoring system.

FIG. 9 is a block diagram of an example computing environment suitable for implementing various examples.

FIG. 10 is a block diagram showing one example of items of a crop harvest characteristic monitoring system in communication with a remote server architecture.

FIGS. 11, 12, and 13 show examples of mobile devices that can be used in a crop harvest characteristic monitoring system.

FIG. 14 is a block diagram showing one example of a computing environment that can be used in a crop harvest characteristic monitoring system.

### DETAILED DESCRIPTION

For the purpose of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example can be combined with the features, components, and/or steps described with respect to other examples of the present disclosure.

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form to facilitate describing the claimed subject matter.

The methods and systems disclosed herein, for example, may be suitable for use in different harvesters and harvesting applications. That is, the herein disclosed examples can be implemented in different harvesters other than for particular types of crops and/or harvesting systems (e.g., other than for specific combine harvester vehicles for particular harvesting applications, such as for particular grain harvesting) to analyze a crop harvest characteristic (e.g., a harvest characteristic level) or other agricultural characteristic (by analyzing one or more images) that results in improved performance to determine when operational changes are needed.

For example, one or more herein described examples allow for improved analysis of characteristics, such as crop harvest characteristics, for instance an agricultural characteristic (e.g., soil moisture or other ground conditions), a machine characteristic (e.g., harvester operating conditions or parameters), a performance characteristic (e.g., chopping quality, residue spread quality, processing level, grain loss, etc.), and/or a crop characteristic (e.g., down crop or standing crop, crop moisture, grain quality (good grain or bad grain), crop state, etc.), among others.

As detailed herein, one or more characteristics (e.g., crop harvest characteristics) are analyzed to inform a control system as to the conditions or context of the agricultural work machine operation (e.g., harvesting operation) such that improved real-time operational setting adjustments can be made. In one particular example as described in more detail herein, one or more crop harvest characteristics, in the form of one or more performance characteristics (e.g., residue performance characteristics such as chopping quality, residue spread quality, etc.), are analyzed that more effectively inform a control system as to the actual performance of the residue subsystem of the harvester. As such, improved real-time operational setting (e.g., operational settings of the residue subsystem, etc.) adjustments can be made.

It should be appreciated that one or more examples described herein can be implemented in connection with any type of crop harvest characteristic in the agricultural harvesting process including before processing of the crop, during processing of the crop, or after processing of the crop. That is, the present disclosure contemplates systems and arrangements used in processed and/or not processed agricultural environments or applications (e.g., processed crop applications or pre-processed crop applications).

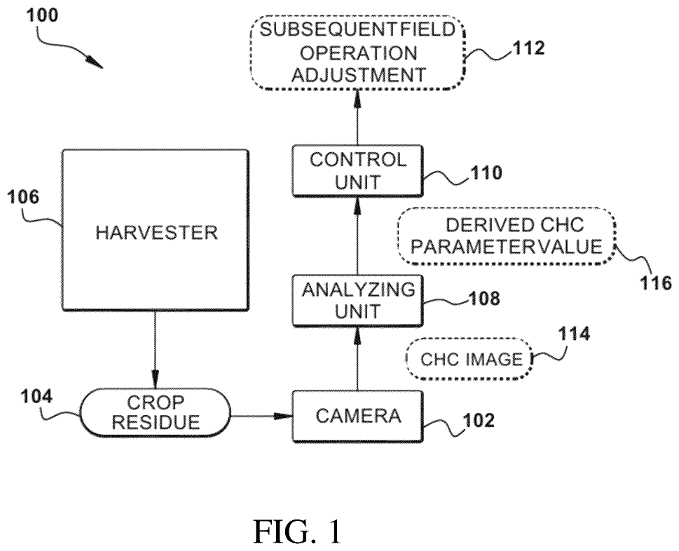

FIG. 1 illustrates an example characteristic monitoring system, illustratively referred to as crop harvest characteristic monitoring system 100. The crop harvest characteristic monitoring system 100 in some examples utilizes an imaging device, such as a camera 102, to capture one or more images (e.g., one or more images of the crop residue 104 generated by a harvester 106). In one example, a processing unit, such as an analyzing unit 108 (e.g., a crop residue quality processing system) then determines or derives a value for the crop harvest characteristic (e.g., residue performance), such as a value for a characteristic of residue performance based upon an optical analysis of the image and that can be used to categorize a level of the residue performance corresponding to the image. A control unit 110 utilizes the value of the crop harvest characteristic and probability information as described in more detail herein to adjust a subsequent field operation 112 (e.g., generate a control signal to adjust one or more operational settings, such as settings of one or more controllable subsystems of the harvester 106). As a result, the subsequent field operations may be adjusted for improved operation based on the current conditions (e.g., improved residue subsystem operation based on the current residue performance). It should be appreciated that while a specific example as described herein relates to crop harvesting and residue performance, various implementations of the crop harvest characteristic monitoring system 100 are configured to operate to analyze any agricultural characteristic, machine characteristic, performance characteristic, crop characteristic, etc.

In various examples, the harvester 106 is an agricultural machine that separates crop plants from the growing medium and processes the crop plants to separate the targeted portion of the crop plant, such as grain, from unwanted portions of the crop plant, such as straw, chaff, or other crop residue. In one implementation, the harvester 106 is a combine harvester that separates grain, such as corn, wheat, oats or the like from the remaining crop residue 104 using a threshing mechanism and a cleaning mechanism. The threshing mechanism may include a straw walker or threshing rotor. The cleaning mechanism may include a chaffer or sieve through which the grain falls and from which the crop residue, such as straw are chaff, is blown rearwardly for discharge and spreading, by a spreader. In some implementations, the harvester 106 additionally includes a chopper, which chops the crop residue prior to this discharge, and can be controlled in accordance with one or more examples.

In one or more examples, the camera 102 captures images of the crop residue 104 generated by the harvester 106. In one implementation, the camera 102 captures the image of the crop residue 104 after the crop residue 104 has been discharged and spread by the harvester 106. It should be noted that the camera 102 can be any type of imaging device and can be provided by, for example, a satellite, drone, tillage machine or other platform separate from the harvester 106 generating the crop residue. In some implementations, the camera 102 used to capture the image(s) of the crop residue 104, prior to discharge or after discharge from the harvester 106, is coupled to the harvester 106. For example, in some implementations, the camera 102 is located to capture images of the crop residue 104 as the crop residue 104 is being blown from a sieve or chaffer towards a rear residue spreader of the harvester 106. In some implementations, the camera 102 is located to capture images of the crop residue 104 as the crop residue 104 is being directed from a straw walker or threshing rotor towards a rear residue spreader of the harvester 106. In some implementations, the camera 102 is located to capture images of the crop residue 104 after the crop residue 104 has undergone chopping, but before the chopped crop residue 104 has been spread by the rear residue spreader of the harvester 104. In some other implementations, the camera 102 is located to capture images of the crop residue 104 after the crop residue 104 has been discharged. In some implementations, multiple cameras 102 are utilized to capture images of the crop residue 104 at more than one of the above described stages. These are merely some examples of the locations and fields of view of camera 102 and are described with reference to residue monitoring. In other examples, camera 102 can be mounted at various other locations with various other fields of view to captures images of other characteristics of interest.

In one or more examples, the analyzing unit 108 is or includes a processing unit configured (e.g., programmed with instructions contained on a non-transitory computer-readable or machine-readable medium) to analyze the image(s) to determine residue performance characteristics (e.g., chopping quality, residue spread quality, etc.). The analyzing unit 108 receives one or more captured crop harvest characteristic (CHC) image(s) 114 (e.g., a performance characteristic subset) acquired by the camera 102 and determines or derives a value 116 for a CHC of the crop residue 104 (e.g., a residue performance characteristic value such as chopping quality value, a residue spread quality value, etc.) based upon an optical analysis of the image(s) 114. The crop harvest characteristic for which the value 116 is determined or derived include, but are not limited to, at least one of chopping quality (e.g., chop size, such as length of residue pieces, etc.) crop residue moisture, crop residue constituents, residue spread quality (e.g., crop residue dispersion (width, distribution), etc.). In one implementation, the values 116 may be determined or derived by the analyzing unit 108 to optically identify individual pieces of crop residue 104 and determine values for the individual pieces of crop residue 104. For example, the analytical or analyzing unit 108 may measure a length of multiple pieces (or groups of pieces) of crop residue 104, wherein the value of the crop harvest characteristic is the value 116 of the residue performance and may be based upon a count of the number of pieces having each of a plurality of lengths. In some implementations, the value 116 may correspond to a performance characteristic category, wherein the analyzing unit 108 includes a processing system (e.g., a neural network) that determines or derives the category for the crop harvest characteristic. For example, a neural network is trained using images having assigned categories and determining similarities (e.g., similar characteristics) between the images. As described in more detail herein, one or more implementations are trained to analyze images and establish a category of the image (e.g., establish a category of the CHC characteristic of the image), as well as to output a probability value for the categorization. The probability value can be used by the control unit 110 in some examples to determine whether a change in the CHC (e.g., residue performance) is occurring and to adjust operational settings of the harvester, such as settings of the residue subsystem or other machine operational settings, (e.g., the subsequent field operation adjustment 112) in response to changes in the CHC (e.g., residue performance) based at least in part by the analysis of a change in a category probability. For example, in one or more implementations, the images 114 are classified using probability values associated with multiple categories instead of individual or single categories, thereby improving residue performance (e.g., chopping quality, residue spread quality, etc.) analysis.

In some implementations, and merely describing one example, the analyzing unit 108 determines or derives different values for the characteristic (e.g., crop harvest characteristic), which in some examples is a performance characteristic, such as a characteristic of residue performance (e.g., characteristic of residue spread quality such as a crop residue distribution, a characteristic of chopping quality such as chopping size, etc.), across a portion of crop residue 104 (e.g., across a width of a row and/or along the length of the row) across the field. Such information may be linked to geo-referenced data (acquired through a geo-referencing system such as GPS based geo-referencing system) to form a performance characteristic map (e.g., a crop residue performance field map) that may be used for adjusting substantive field operations. For example, with respect to a crop residue distribution, a first portion of a width of a row of discharge crop residue 104 may have a first determined or derived value for a particular characteristic of residue performance (e.g., crop residue distribution) while a second portion of the width of the row of discharge crop residue 104 may have a second determined or derived value for the particular characteristic of residue performance (e.g., crop residue distribution) different than the first determined or derived value. Likewise, the row or widthwise portions of the row at a first geo-referenced location at a first point in time may have a first determined or derived value for the particular characteristic of residue performance (e.g., crop residue distribution) whereas the row or widthwise portions of the row at a second geo-referenced location (downstream or down field from the first geo-referenced location) at a second later point in time may have a second determined or derived value for the particular characteristic of residue performance (e.g., crop residue distribution). By determining or deriving different geo-referenced residue performance characteristic (e.g., crop residue distribution) values across portions of the crop residue, and classifying the images 114 using probability values associated with multiple categories, field operations are adjusted based upon information having a higher degree of resolution, thereby improving harvesting performance (e.g., residue chopping performance, residue spread performance, etc.). By determining or deriving different geo-referenced crop harvest characteristics at different points in time as a harvester traverses a field, and using probability values associated with multiple categories, subsequent field operations may be adjusted to accommodate changing conditions even as a harvester moves across a field. It should be noted that the probability values associated with multiple categories (e.g., probability values for a level of processing for the performance characteristics, such as an amount or quality of chopping, or other characteristics) can be provided with different crop residue distribution value calculations, different types of image analysis, different operating parameters, etc.

In one or more examples, the control unit 110 includes a processing unit that adjusts subsequent field operation 112 based at least in part on probability values associated with multiple categories of images. That is, the control unit 110 performs control operations in some examples based on a probability evaluation or analysis instead of a classification only evaluation or analysis. In one implementation, the control unit 110 is part of a different agricultural machine, other than the harvester 106, that carries out the subsequent field operation 112. In one implementation, the subsequent field operation 112 adjusted by the control unit 110 may include subsequent operations to the same geo-referenced regions by different agricultural machines other than the harvester 106. For example, subsequent tillage settings for tillage machines may be adjusted based upon the value 116 of the crop harvest characteristic. Subsequent spraying or planting operations may be adjusted based upon the value 116 of the crop harvest characteristic at different geo-referenced locations or regions. In some implementations, the operational settings of the agricultural machine having the control unit 110 may remain the same, but the parameter of a subsequent applied material may be adjusted by the control unit 110 based upon the value of the crop harvest characteristic. For example, a type, density or other characteristic of seed, of applied herbicide, of applied insecticide, of applied fertilizer or of other applied materials may be adjusted based upon the value 116 of the crop harvest characteristic.

In some implementations, the control unit 110 may be part of the harvester 106. The control unit 110 in some examples adjusts the operational settings of the harvester 106 during a subsequent harvesting season, during the same harvesting season, or during the same pass of the harvester 106 across the same field, based upon the value 116 of the crop harvest characteristic. For example, one or more operational settings of the harvester 106 may be adjusted minutes or hours after the value 116 for the crop harvest characteristic value has been determined or derived, while the harvester 106 is traversing the same field, based upon the determined or derived crop harvest characteristic value 116. Examples of such operational settings include, but are not limited to, chopper speed, harvester speed, harvester feed rate, chopper counter knife position, header height, spreader speeds, spreader vane positions, threshing speed, cleaning speed, threshing clearance, and sieve louver positions. In some implementations, the different determined or derived crop harvest characteristic values 116 may be displayed to an operator (such as within the cab of the harvester 106), wherein the operator may make additional or alternative manual adjustments to the harvester 106 during harvesting.

In yet other implementations, the control unit 110 is a remote controller that provides control signals to the harvester 106 and/or the other agricultural machine. The control unit 110 utilizes the determined or derived crop harvest characteristic value 116 (based in part on the probability analysis) to output control signals adjusting the subsequent field operation 112. In some implementations, the control unit 110, as part of the harvester 106 or as a remote controller, utilizes the determined or derived crop harvest characteristic value 116 output by the analyzing unit 108 to generate a field map linking different geo-referenced regions to different crop harvest characteristic values 116. For example, the harvester 106 may carry a geo-referencing device, such as a global positioning satellite transceiver, wherein the determined or derived crop harvest characteristic values received from the analyzing unit 108 are linked to the associated location or region of the field as provided by the geo-referencing device. The generated crop harvest characteristic (e.g., residue performance) field map may be used as a basis for adjusting or controlling subsequent field operations 112 to the particular geo-referenced regions.

In one or more examples, the control unit 110 performs control operations based on probabilities of categorized images 114 instead of a simple classification. As an example, during operation of the harvester 106, the size of straw residue created by the harvester 106 may be difficult to determine based on the operational environment and the sensor types used. For example, measuring individual straw lengths can be computationally heavy, and classifying an image into a singular category, even when the performance may be bordering on a threshold level, can be challenging for control systems to determine when an operational change is needed. In one or more examples, a method of analysis for residue performance (e.g., chopping quality, residue spread quality, etc.) informs the control system 110 more effectively (and with lower computational operation) as to the actual performance of the residue subsystem by determining a change in residue performance using the images 114 that are classified using probability values associated with multiple categories. The analysis for residue performance provides for managing field operations using improved crop harvest characteristic values 116 or crop residue information. It should be noted that although examples are described in connection with the crop harvest monitoring system 100, one or more operations can be carried out by any of the other described implementations, including using different characteristics or criteria as described in more detail herein, such as with differently configured monitoring systems.

For example, in operation, the camera 102 captures images 114 of the crop residue 104 generated by the harvester 106. The images 114 may be captured at a point in time before or after discharge of the crop residue 104 by the harvester 106. In some implementations, the camera 102 may capture images of the crop residue 104 at multiple different locations inside of the harvester 106 as well as outside of the harvester 106. The images 114 may be captured by the camera 102 mounted to the harvester 106, by an airborne camera or by an agricultural machine that subsequently crosses the field. That is, in one or more examples, any type of imaging device can capture the images 114 of the crop residue 104, such as chopped straw material.

The analyzing unit 108 derives the value 116 for the crop harvest characteristic of the crop residue 104 generated by the harvester 106 based upon an optical analysis of the images 114 of the crop residue 104. The crop harvest characteristic for which values may be derived include, but are not limited to, at least one of chop size, crop residue moisture, crop residue constituents and crop residue dispersion (spread width, distribution, etc.). In one implementation, the values may be determined or derived by the analyzing unit 108 by optically identifying individual pieces of the crop residue 104 and determining values for the individual pieces of crop residue 104. For example, the analyzing unit 108 may measure a length of each of the pieces of crop residue 104, wherein the value 116 of the crop harvest characteristic may be based upon a count of the number of pieces having each of a plurality of lengths. In some implementations, the value 116 of the crop harvest characteristic may be associated with or determine a crop harvest characteristic category, wherein the analyzing unit 108 is trained to analyze the images 114 and establish a categorization of the images 114. In one or more examples, a neural network or machine learning is used to train the analysis that derives the category for the crop harvest characteristic as described in more detail herein. Using this training, the image(s) 114 in various examples can be labeled in a category, for example, with regard to residue chopping quality, the image(s) can be labeled in a category based on an amount of determined processing of the residue, such as under processed, over processed, or ideal. That is, the image(s) 114 in some examples can be categorized as under processed (e.g., length of residue is longer than desired), over processed (e.g., length of residue is shorter than desired), or ideally processed (e.g., length of residue is as desired).

It should be noted that in one or more implementations, the value 116 comprises a numerical statistic such as average residue/straw length. In another implementation, the value 116 comprises a categorization of the crop residue such as a type of crop residue, percent of different types of crop residue found in the image or the like. In another implementation, the value 116 comprises a categorization of the crop residue in terms of processing of the crop residue as described in more detail herein, such as under processed, over processed, or ideally processed, and the like, wherein the “processing” refers to the degree to which the crop residue has been changed or reduced in size by the harvester 106. As should be appreciated, and described above, the value 116 can relate or correspond to any crop harvest characteristic, such as an agricultural characteristic, a machine characteristic, a performance characteristic, and/or a crop characteristic, among others. Further, the categories into which images can be different in accordance with the particular harvest characteristic, for instance, using residue spread as an example, the categories could be “overspread” (e.g., residue is spread more, such as wider, than desired), “underspread” (e.g., residue is spread less, such as more narrowly, than desired), or “ideal” (e.g., residue is spread as desired).

In implementations where the value 116 comprises a numerical statistic, the value 116 may be determined or derived by optically identifying individual pieces of the crop residue 104, individual pieces of straw, chaff, and the like in measuring a characteristic of the individual pieces, such as the length of the individual pieces using optical analysis. Such identification may be carried out by applying various optical filters to the image(s) 114 to distinguish between individual pieces and then measuring the individual pieces using the detected edges of the individual pieces and the scale of the image(s) 114 being analyzed. The statistical value may be generated by counting the various pieces of a given length range or other sized range. The statistical value may be output or may be compared against a threshold, wherein the categorization of the crop residue is output based upon the comparison of the statistical value to the threshold. As will be described in more detail herein, a probability associated with the categories is also determined. That is, a probability of the accuracy of the categorization is determined in various examples, such as using an algorithm trained to analyze images and establish the categorization of the images, wherein the algorithm outputs the probability value of the categorization. As such, by classifying images using probability values associated with multiple categories, a more accurate characteristic (e.g., residue performance, such as residue chopping quality, residue spread quality, etc.) analysis can be performed.

One or more example implementations will now be described. As should be appreciated, some image processing applications can be challenging when operating in an environment that may produce many images that have elements of many classification categories in them. Selection of a single classification for each image may be possible, but would result in a signal that would be very noisy and thus difficult to use in a control system. For example, when several images are input to a classifier that has been trained as a neural network to recognize categories of ‘over processed,’ ‘ideal’ and ‘under processed’ length straw, the plot can have changing values across each of the images. The values in the plot can represent ‘under processed,’ ‘ideal’ and ‘over processed’ categories, in some examples.

In various implementations as described in more detail herein, in lieu of using a simple classification output of a neural network, a probability analysis of each image can be conducted to determine probabilities that each image fits into each of the classifications. The probability values, such as percentage values, of each image indicating the probability of each image fitting into each of multiple categories can be summed to a set sum total (e.g., one hundred percent). As should be appreciated, when plotting the probability value of each classification for each image, the signal may be considered unstable (e.g., due to fast signal changes between designated classification values for the plot), and likely unusable if this information were provided directly as a signal to a control system. That is, when operating, each image, of a plurality of images, being used in control may each (or at least often) have a different highest probability classification and thus, if using directly as a signal to a control system, the signal may be unstable (change highest probability classification quickly) and thus result in unstable operation (e.g., frequent change in control). Thus, filtering (e.g., aggregating) images (or values thereof) can help to stabilize the control input. Further, even if not aggregating, utilizing all probability values of each image, rather than the highest probability value for each image, can also be useful in stabilizing control, by more easily seeing trends or comparative change in performance.

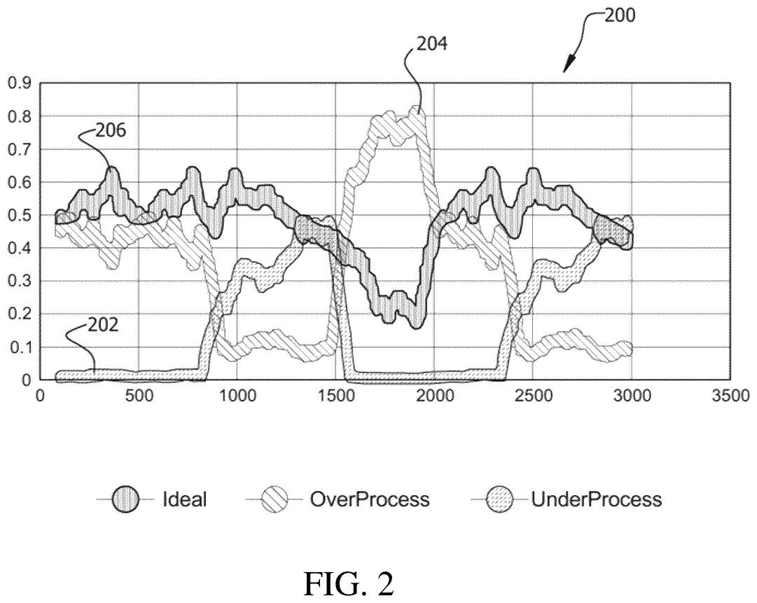

However, as described in more detail herein, the probability information can be useful when it enables a user or operator to see the context for what is occurring in the performance characteristics. For example, utilizing one or more ‘filtering’ techniques, such as aggregating (e.g., averaging) images together (e.g., using a buffer of multiple images and aggregating, such as averaging, probability values thereof), a more stable signal value (e.g., smother plot) can be obtained relative to each classification. For example, as can be seen in FIG. 2, with an ‘averaging’ filter on the values, the signal is more stable (e.g., smoother). It should be noted that ‘averaging’ is just one method of filtering, and other filtering methodologies, including other forms of aggregation, can be applied. As can be seen, a buffer of about fifty (50) images is established (i.e., the plots do not begin until about image 50). Wherein the first value (along the Y axis) for the plot is the aggregated (e.g., averaged) value of the first 50 images (images 1 through 50). The second value (along the Y axis) for each plot is the aggregated (e.g., averaged) value of the images 2-51. As can be seen in FIG. 2, the plot provides for smoother transitions to readily observe that as a machine (e.g., the harvester 106) travels through a field over time, the performance changes. In this example, plotting the image number along the X-axis, if an image is taken at a consistent frequency, a time series plot results. Further, in some implementations, the ‘image’ count (e.g., number of images in a pseudo time series plot) may be utilized as a geo-reference data set (e.g., for a map) by associating the GPS location of the machine at the time of the image. Thus, this methodology can be applied to image counts, time series data, or geo-referenced data. In any of these instances, the changes in values relative to each other over time are more readily seen using the filtered data plots, indicating changes in performance.

As an illustrative example, for context, probability values for the ‘under processed’ category may initially be lower than ‘over processed’, at about image 800 the probability values begin to trend upward and continue until about image 1500. So, in this example, while the ‘under processed’ value may be lower than the probability values for ‘over processed’ (e.g., or vice versa depending on how values are determined) for much of the time, there appears to be a shift or change in the performance occurring (e.g., at about image 800). In this way, a control system, or an operator that is receiving a similar signal feedback through a display interface can be alerted in order to make decisions sooner with respect to how that signal is behaving.

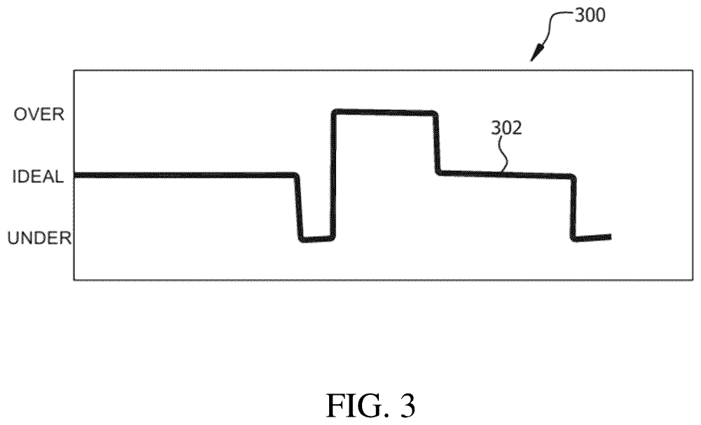

For example, rather than waiting for the ‘under processed’ probability value to suddenly be the highest value, a system can take action before that event to mitigate the ‘under processed’ probability value from exceeding the other values or a target value. Thus, plots such as those shown in FIG. 2, can be useful to take action before that event. Further, in some examples, trying to classify the performance into the three categories based on the filtered probability may not be useful (e.g., where the signal suddenly seems to become unstable in switching between the classification with the highest probability (filtered).Thus, a plot such as that shown in FIG. 3 may be less useful than plots such as those shown in FIG. 2 when conditions at the field (or resulting crop harvest characteristics) are highly variable, but may be more useful than plots such as those shown in FIG. 2 when conditions at the field (or resulting crop harvest characteristics) are more stable.

As another example, when observing the probability values (filtered), there may be situations when the signals are relatively stable for a period of time, and may also be close together, which can result in sudden and frequent changes in the classification output (e.g., if using the highest probability value to output a resulting classification). In these situations, prior to and after this sudden change, trends in both the ‘ideal’ and ‘over processed’ could be identified to give additional context to the control system or operator. As such, the use of the probability values can give more context and provide a more accurate representation of the performance or changes in performance that can be used by the control systems or the operators (through use of display interfaces) to make more informed decisions.

The use of ‘over processed,’ ‘ideal,’ and ‘under processed’ for classifying images (e.g., or other data) are merely example classification categories. It should be appreciated that other types of classifications may be used in these or similar performance characteristics.

Further, not all applications of crop harvest characteristics will utilize the same categories or classifications, and the categories or classifications can vary dependent on what type of crop harvest characteristic is being evaluated. For example, a forward looking camera system may observe a crop characteristic, such as a crop state that is in front of the machine, using example categories of ‘down crop,’ ‘standing crop,’ ‘leaning crop,’ or ‘no crop’ as just a few examples. In other examples of crop harvest characteristics classification, a quality of the grain sample can be assessed using cameras that are more internal to the machine and in proximity to material as the material flows through the machine and could include categories of ‘poor,’ ‘good,’ ‘great’ or other similar terms.

In various implementations, the system may use an image capture device, positioned to capture the crop harvest characteristic of interest (e.g., a crop characteristic, an environmental characteristic, a machine characteristic, performance characteristic, etc.). In this example, the images are provided to an analysis module (located on a controller-onboard or off-board the machine) that contains the algorithm to classify each image, and as part of that classification, determine the probability of the classification categories for each image as described in more detail herein. Subsequently, a data filtering can optionally be performed, and the values (or trends in the values) can be used by a control system or displayed to an operator, as also described in more detail herein.

One particular example will now be described wherein FIG. 2 illustrates a classification (or categorization) graph 200 that plots probability values for images of crop residue, corresponding to the crop residue classification (or category), such as under processed, over processed, or ideally processed. In the graph, the X-axis represents images (image count) and a Y axis represents a probability value assigned to the images at each point (each point along the X axis), where the probability value represents the probability that the images belong to a particular classification category. As previously described, in the example of FIG. 2, filtering (e.g., aggregation) is performed, such that each plotted Y axis value along each point of the X axis represents a filtered (e.g., aggregated) value from multiple images (e.g., 50 images). As such, in this example, the vertical (Y) axis represents a probability value (e.g., here, expressed as a decimal number, such as 0.5 or 50%) of the categorization for the particular images. Specifically, in this figure, a plot 202 represents a probability associated with each aggregated set of images that the imaged crop residue is under processed, a plot 204 represents a probability associated with each aggregated set of images that the imaged crop residue is over processed, and a plot 206 represents a probability associated with each set of aggregated images that the imaged crop residue is ideally processed. That is, the classification graph 200 shows an analysis performed to determine the probability that the crop residue shown in each of the images 114 corresponds to a given classification category (e.g., is under processed, over processed, or ideally processed). As such, for each horizontal point (along the X axis) in the classification graph 200 corresponding to different images, the sum of the probability for the plots 202, 204, 206 is 100% (e.g., probability of under processed+probability of over processed+probability of ideally processed=100%). Thus, the classification graph 200 corresponds to a classification (or categorization) analysis wherein the images 114 are processed (e.g., using the trained neural network) to determine a probability for each classification or categorization (e.g., under processed, over processed, or ideally processed) corresponding to each of the images 114.

FIG. 3 illustrates a probability graph 300 showing a plot 302 representing the categorization having the highest probability value for each (or each aggregated set) of the images 114 (e.g., the highest probability value of falling into one of the classifications: under processed, over processed, or ideally processed) as described in FIG. 2. That is, instead of representing the probability of three different classifications of the images 114 as under processed, over processed, or ideally processed, the plot 302 represents the classification corresponding to the highest probability associated with each (or each aggregated set) of the images 114. That is, in this example, this highest probability classification describes whether each (or each aggregated set) of the images corresponds to crop residue that is most likely under processed, over processed, or ideally processed (e.g., categorize based on the plot 202, 204, 206 having the highest value for each of the images). As such, while FIG. 2 illustrates trends for the values (e.g., changing slopes of the plots 202, 204, 206) and the relationships between the plots 202, 204, 206 (e.g., the separation between the plots), FIG. 3 is representative of the most likely categorization for each of the images 114.

Thus, the plot 302 corresponds to a filtered analysis, namely filtering the signals corresponding to the plots 202, 204, 206 (which as can be seen in FIG. 2 can include rapid changes in the probability values) to allow for easier identification or determination of the most likely classification or categorization of the images being under processed, over processed, or ideally processed along a “smoother” signal (e.g., a stepwise plot). As previously discussed, the each of the different kinds of plots (e.g., 302 or 202, 204, and 206) may be more or less useful than the other depending on conditions at the field (e.g., variability, etc.). Thus, in some circumstances, a plot, such as 302, may be more desirable for use in control than a plot, such as 202, 204, and 206, whereas, in other set of circumstances, the plot, such as 202, 204, and 206, may be more desirable than a plot, such as 302. It should be appreciated that the categorized labels (under processed, over processed, or ideally processed) in FIGS. 2 and 3 are merely examples, and different labels can be used, such as corresponding to different crop harvest characteristics as described in more detail herein.

Thus, FIG. 3 is the graph 300 that plots a singular classification for each (or each aggregated set) of the images. That is, each ‘point’ along the X-axis of the graph 300 represents a singular image (or a singular set of aggregated images). And based on the classification in a neural network classification system, each image (or each set of aggregated images) is assigned a single value based on what category or classification the imaged residue performance (or other crop harvest characteristic) most closely (most likely) matched. The plot 302 in FIG. 3 shows only the highest probability classification of each (or each aggregated set) of the images. As such, the plot 302 is based on ‘filtered’ probability values from FIG. 2. Therefore, when only the most probable classifications for each image (or each set of aggregated images) are used, classifications may be challenging to understand, such as when the condition might change because this type of plot 302 is simply selecting the most likely categorization. Whereas in FIG. 2, when analyzing the probability for each category corresponding to each image (or each set of aggregated images), the similarity and dissimilarity of the images (or aggregated sets of images) are more identifiable by the probability (and the trend/filtering) of the probabilities over time. Otherwise, the control system may have difficulty implementing adjustments if they are changed every time the value is switched from, for example, ‘ideal’ to ‘over processed’.

In some examples, the plot 302 is used as a system input control, such as for use by the operator or for use by the control unit 110. In yet other examples, the plots 202, 204. and 206 are used as a system input control, such as for use by the operator or for use by the control unit 110. As should be appreciated, using the probability values over time (as shown in various examples) and monitoring the relationship between the probabilities, as shown in FIG. 2, can be a more effective way to provide control of the system.

In some examples, the control unit 110 may comprise a neural network or other machine learning or be trained using a neural network or other machine learning to classify the images 114 and to determine a probability for the corresponding classifications. For example, the neural network may derive a category for the crop harvest characteristic by being trained using a plurality of images having preassigned category values as described in more detail herein. In one implementation, the preassigned category values may be developed during a training phase. The training phase may be a one-time occurrence or may be repeatedly carried out in response to operator requests, in response to sensed triggering events or after predefined lapses of time or acreage traversed. The training phase may include receiving images that have ground truth category labels. For example, one or more individuals may assign category labels to given images of crop residue. The neural network may then optically analyze the same images of crop residue and identify various category criteria for the different categories or labels based upon an optical analysis of the images and the ground truth category labels.

The training phase may also include at least one verification and adjustment phase, wherein the control unit 110 receives a second set of images that also have been given ground truth category labels. The control unit 110 may then apply the identifying category criteria to label the second images with analytical unit-based category labels. These analytical unit-based category labels may be compared against the human-based category labels to see how close the analytical unit-based category labels correspond to the human-based category labels. Based upon this comparison, the identified category criteria may be adjusted. This process may be iteratively repeated until the analytical unit-based category labels for a given set of images match or correspond to the human-based category labels for the same set of images, at least to a desired level of matching or corresponding.

In one or more examples, sets of the images 114 are categorized using the trained control unit 110, such as by determining corresponding probabilities for the images 114 (e.g., probability that the image corresponds to residue that is under processed, over processed, or ideally processed). For example, one or more probability values are determined as described in more detail herein. The probability value(s) are input to the control unit 110, which is used to determine whether a change in the crop harvest characteristic is occurring, and to adjust the characteristic, such as by adjusting one or more machine operational settings, in response to the changes in the crop harvest characteristic determined by the analysis of a change in the probability value(s). For example, the control unit 110 may adjust the subsequent field operation 112 based on analyzing images as described in more detail herein to determine the crop harvest characteristic values (either a singular categorization or the probabilities of each categorization). In one implementation, the subsequent field operations 112 adjusted by the control unit 110 may comprise subsequent operations to the same geo-referenced regions by different agricultural machines other than the harvester. For example, subsequent tillage settings for tillage machines may be adjusted based upon the values. Subsequent spraying or planting operations may be adjusted based upon the values at different geo-referenced locations or regions.

In some implementations, the operational settings of the agricultural machine, such as the harvester 106, may remain the same, but the parameter of a subsequent applied material may be adjusted based upon the values. For example, a type, density or other characteristic of seed, of applied herbicide, of applied insecticide, of applied fertilizer or of other applied materials may be adjusted based upon the values. In yet other implementations, the operational settings of the harvester 106 during a subsequent harvesting season, during the same harvesting season or during traversal of the harvester across the same field may be adjusted based upon the values as described in more detail herein.

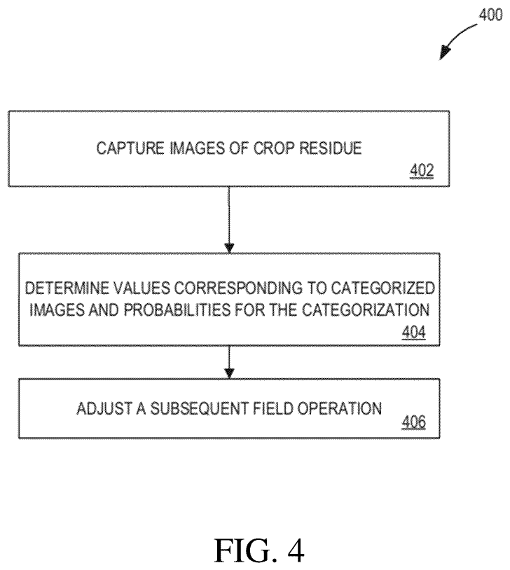

FIG. 4 is a flow diagram of an example method 400 for managing field operations using crop harvest characteristic (e.g., crop residue performance) information, including image classification probability values. The method 400 is described in the context of being used in connection with the crop harvest monitoring system 100. However, it should be appreciated that method 400 may likewise be carried out by any of the other described implementations (e.g., performed using one or more configurations described in more detail herein). The method includes capturing one or more images of crop residue at operation 402. For example, one or more of the images 114 of the crop residue 104 generated by the harvester 106 are captured by the camera 102. The image(s) 114 may be captured at a point in time before or after discharge of the crop residue 104 by the harvester 106. In some implementations, as described herein, the camera 102 may capture the images 114 of the crop residue 104 at multiple different locations inside of the harvester 106 as well as outside of the harvester 106.

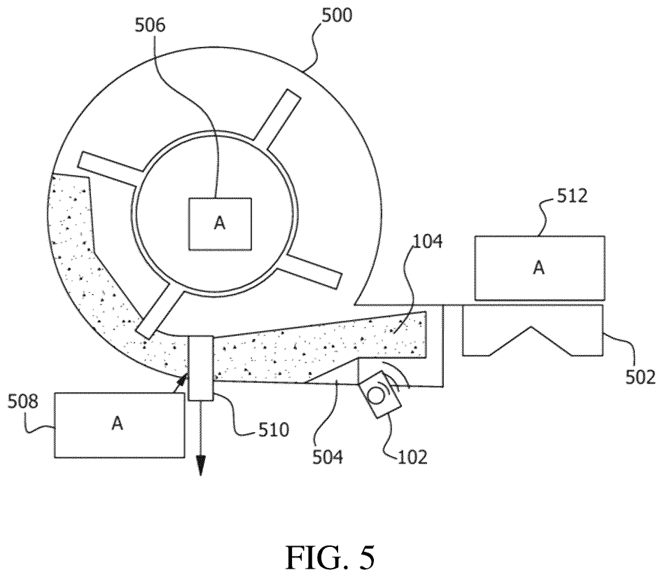

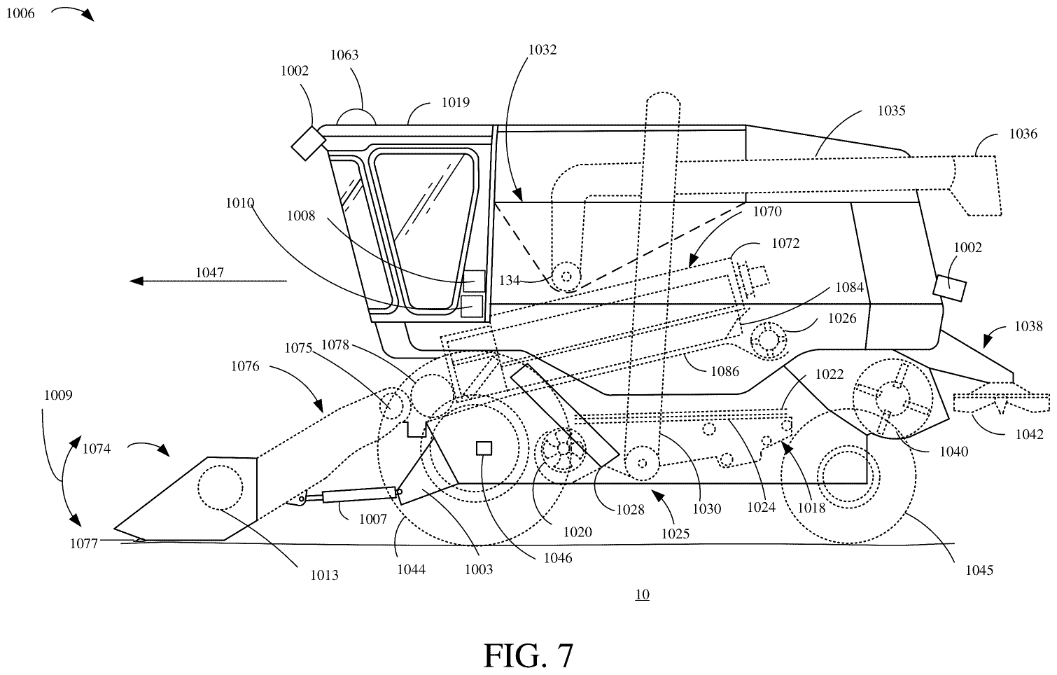

For example, as illustrated in FIG. 5, the camera 102 can be supported by a frame of the harvester 106 so as to be focused on interior regions of harvester 106 to capture images of crop residue 104 being blown from chaffer/sieve towards a chopper 500 and a spreader 502. In this example, the camera 102 is supported by the frame so as to be focused on interior regions of the harvester 106 between the chopper 500 and the spreader 502. The camera 102 captures images of crop residue 104 after being chopped by the chopper 500 and prior to being discharged and spread by the spreader 502. In this example, the camera 102 is supported between the chopper 500 and the spreader 502 downstream of a deflector 504. The deflector 504 comprises a ramp or other structure that directs the flow of crop residue 104 over and above the camera 102, reducing direct impacts with the camera 102 and protecting the camera from the damaging flow of crop residue 104. In other examples, the camera 102 can be mounted in other positions or orientations, such as at the rear of the harvester 106 (e.g., as shown in FIG. 7) and focused on the crop residue 104 that is being discharged onto the ground. In addition to providing an image depicting the constitution of the crop residue 104, the camera 102 provides an image that may be used to determine the characteristics of the spread of crop residue 104 on the ground. In the example illustrated, the crop residue 104 is spread by the spreader 502 in a row tailing from the harvester 106 as the harvester 106 traverses a field.

As described herein, images produced by the camera 102 may be used by the control unit 110 to identify different crop harvest characteristics, as well as to identify the different constituents and different values for crop harvest characteristics for each of multiple portions of the field, as well as to categorize the images and determine corresponding probability values for the categorization. The control unit 110 in some examples may output control signals to different components, such as an actuator 506 (such as a hydraulic or electric motor) so as to adjust the speed of the chopper 500 or other machine components. In some examples, the control unit 110 may additionally or alternatively output control signals to an actuator 508 (such as a hydraulic cylinder or a solenoid) to adjust the position of a chopper counter knife 510 as indicated by the arrow, wherein the positioning affects the degree to which the residue is chopped by chopper 500. In some examples, the control unit 110 may additionally or alternatively output control signals to an actuator 512 (such as a hydraulic or electric motor) to adjust the speed of spreader 502 or the positioning of vanes of the spreader 502. In some examples, the control unit 110 may additionally or alternatively output control signals to adjust other operational settings, such as adjusting the header height, adjusting a threshing speed, separation speed, threshing clearance or sieve louver positions, and/or adjusting the speed of the harvester 106 crossing a field or the rate at which crops are fed through harvester 106 by the various augers, conveyors and components of harvester 106, among others.

Referring again to FIG. 4, the method includes, at operation 404, determining values corresponding to categorizing the images and values for probabilities for the categorization. As described herein, in some examples, an algorithm is trained to analyze the images and establish a categorization of the images, as well as output a probability value(s) of the categorization. For example, the trained control unit 110 labels or categorizes the image(s) based on an amount of determined processing of the crop residue 104 and a probability value associated with the label or categorization is determined.

For example, as described in more detail herein, a neural network is trained to recognize crop residue that is under processed, over processed, or ideally processed (or recognize other crop harvest characteristics). In various examples, probability values associated with each of the classified image(s) are used to determine a likelihood of different categories of processing for each of the images, that is, the probability that the residue is or will be under processed, over processed, or ideally processed. The probability values can be, in some examples, based on aggregated values over time of the classification for each of the images as described in more detail herein, thereby resulting in more reliable information being used to make control decisions. For example, for each image a determination is made as to the probability that the image corresponds to under processed, over processed, or ideally processed crop residue, such as 50% probability that the image corresponds to ideally processed crop residue based on the image processing, 35% probability that the image corresponds to over processed crop residue, and 15% probability that the image corresponds to under processed crop residue. In one or more examples, the determination at operation 404 is based on identifying the most likely categorization using the highest probability values over time. In some examples, instead of looking at differences between residue processing of the individual images (e.g., image analysis of individual images to determine the level of processing to categorize the images), trends in the harvest characteristic level over time are determined. That is, the data from the plots 202, 204, 206 can be used to determine or identify trends in the residue being under processed, over processed, or ideally processed. Thus, in some examples, the data from the plots 202, 204, 206 can be used to identify different trends in the crop harvest characteristics, such as chopping quality, residue spread quality (e.g., percentage of spread corresponding to each image), grain quality, as well as various other crop harvest characteristics etc.

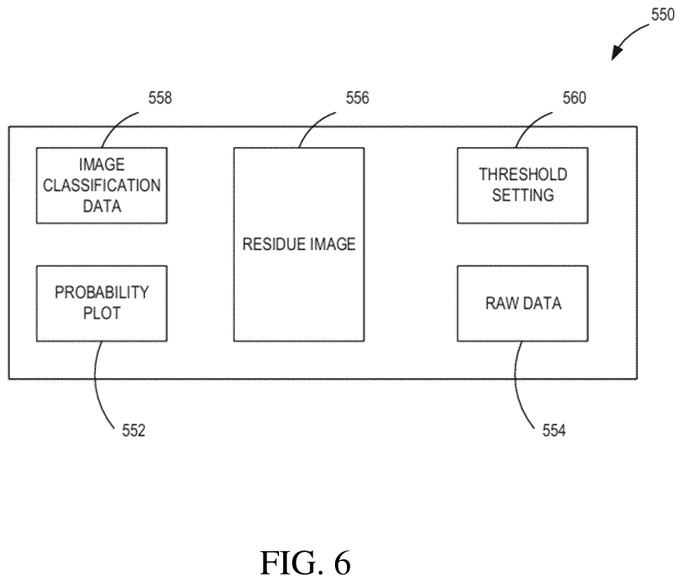

It should be noted that the information determined at operation 404, such as the probability information (e.g., individual image categorization probabilities or trend information) is displayed to a user (e.g., operator of the harvester 106) in some examples. The information may be displayed on a screen or a user interface 550 of the harvester 106, such as displaying actual, averaged or filtered probability information in a plot 552 as shown in FIG. 6. The plot 552 in some examples is based on or corresponds to any of the plots 202, 204, 206, 302 (shown in FIGS. 2 and 3). The information displayed to the user can be provided in different configurations, formats, etc. In one or more examples, the user is able to view the raw data 554 (e.g., individual image analysis data, such as individual probability of each of the images). In other examples, such as those shown by the plots 202, 204, 206, and 302. filtered data (e.g., smoothed probability data) can be viewed by the user. For example, a residue image 556 is displayed by the user interface 550 with the raw data 554 corresponding to the residue image 556 (e.g., probability percentage that the residue image corresponds to under processed, over processed, or ideally processed residue cutting). In some examples, image classification data 558 is also displayed, such as shown by the plots 202, 204, 206, 302 or for subsets of the images. In one or more examples, one or more thresholds can be set based on the determined probabilities, such as by using a threshold setting 560 of the user interface 550 (e.g., set a threshold length or threshold length range for each of the under processed, over processed, or ideal residue cutting classifications, or set a threshold probability value or a probability value difference threshold). It should be appreciated that any type of data or images can be displayed or presented by the user interface 550 in different forms, such as probability values (or trends of different crop harvest characteristics or parameters) or as numerical values, as plots, as differently configured graphs, etc.

At operation 406, a subsequent field operation is adjusted. For example, the control unit 110 adjusts a subsequent field operation based upon the determined values as described in more detail herein. In some examples, the subsequent field operation causes a change in one or more operational settings, such as for residue performance by the harvester 106, including residue size or chopping quality, residue spread quality, etc. That is, not all residue (e.g., straw residue) has the same characteristics, and in one or more examples, the field operation is adjusted based on a target performance level for the characteristic (e.g., a user defined or user input optimal residue sizing, such as optimal length). As such, the characteristic value is adjusted (e.g., residue is sized appropriately, residue is spread appropriately, etc.) for the conditions, type of crop, subsequent harvesting, etc. In some examples, filtering can be performed based on characteristic values to, for example, adjust a sensitivity of the probability analysis. For example, aggregating of images, as discussed elsewhere herein, can adjust the sensitivity of the probability analysis and subsequent control. Further, the sensitivity of the control unit 110 could be adjusted based on the probability values.

Thus, crop harvest characteristic analysis is performed by one or more examples. The analysis allows for improved control of crop harvesting.

FIG. 7 is partial pictorial, partial schematic illustration of an example agricultural work machine in the form of an agricultural harvester 1006 (also called harvester 1006). Harvester 1006 is one example of harvester 106. In the example shown in FIG. 7, harvester 1006 is in the form of a combine harvester. As illustrated in FIG. 7, harvester 1006 includes ground engaging traction elements 1044 and 1045 which can be driven by a propulsion subsystem (e.g., internal combustion engine, electric motors, hydrostatic drive, and other drivetrain elements, such as a gear box) to propel harvester 1006 across a worksite 10 (e.g., a field). While, in the example of FIG. 7, ground engaging traction elements 1044 and 1045 are shown as wheels and tires, in other examples, elements 1044 or 1045, or both, could be other forms of ground engaging traction elements such as track systems. Harvester 1006 includes an operator compartment or cab 1019, which can include a variety of different operator interface mechanisms (e.g., 550 shown in FIG. 6, 818 shown in FIG. 2) for controlling harvester 1006 as well as for presenting (e.g., displaying, etc.) various information. Harvester 1006 includes a feeder house 1076, a feed accelerator 1078, and a thresher generally indicated at 1070. The feeder house 1076 and the feed accelerator 1078 form part of a material handling subsystem 1025. Header 1074 is pivotally coupled to a frame 1003 of harvester 1006 along pivot axis 1005. One or more actuators 1007 drive movement of header 1074 about axis 1005 in the direction generally indicated by arrow 1009. Thus, a vertical position of header 1074 (the header height) above worksite 10 over which the header 1074 travels is controllable by actuating actuators 1007. While not shown in FIG. 7, agricultural harvester 1006 can also include one or more actuators that operate to apply a tilt angle, a roll angle, or both to the header 1074 or portions of header 1074.

Agricultural harvester 1006 includes a material handling subsystem 1025 that includes a thresher 1070 which illustratively includes a threshing rotor 1072 and a set of concaves 1084. Further, material handling subsystem 1025 also includes a separator 1086. Agricultural harvester 1006 also includes a cleaning subsystem or cleaning shoe (collectively referred to as cleaning subsystem 1018) that includes cleaning fan(s) 1020, chaffer 1022, and sieve 1024. The material handling subsystem 1025 also includes discharge beater 1026, tailings elevator 1028, and clean grain elevator 1030. The clean grain elevator moves clean grain into a material receptacle (or clean grain tank) 1032.

Harvester 1006 also includes a material transfer subsystem that includes a conveying mechanism 1034 and a chute 1035. Chute 1035 includes a spout 1036. In some examples, spout 1036 can be movably coupled to chute 1035 such that spout 1036 can be controllably rotated to change the orientation of spout 1036. Conveying mechanism 1034 can be a 21 variety of different types of conveying mechanisms, such as an auger, blower, or belted conveyor. Conveying mechanism 1034 is in communication with clean grain tank 1032 and is driven (e.g., by an actuator, such as motor or engine) to convey material from grain tank 1032 through chute 1035 and spout 1036. Chute 1035 is rotatable through a range of positions from a storage position (shown in FIG. 7) to a variety of deployed positions away from agricultural harvester 1006 such as to align spout 1036 relative to a material receptacle of a material receiving machine that is configured to receive the material within grain tank 1032. Spout 1036, in some examples, is also rotatable, by an actuator, to adjust the direction of the material stream exiting spout 1036.

Harvester 1006 also includes a residue subsystem 1038 that can include, among other things, residue chopper 1040 and residue spreader 1042. Residue chopper can be similar to or the same as residue chopper 500. Residue spreader 1042 can be similar to or the same as residue spreader 502. Residue subsystem 1038 can include various other items as well such as a counter knife similar to or the same as counter knife 510, a deflector similar to or the same as deflector 504, and actuators similar to or the same as actuators 506, 508, 512

In some examples, a harvester within the scope of the present disclosure can have more than one of any of the subsystems mentioned above. In some examples, harvester 1006 can have left and right cleaning subsystems, separators, etc., which are not shown in FIG. 7.

In operation, and by way of overview, harvester 1006 illustratively moves through a worksite (e.g., field) 10 in the direction indicated by arrow 1047. As harvester 1006 moves, header 1074 engages the crop plants to be harvested and cuts, with a cutter bar 1077 on the header 1074, the crop plants to generate cut crop material.

The cut crop material is engaged by a cross conveyor (e.g. cross auger, belts, etc.) 1013 which conveys the severed crop material to a center of the header 1074 where the severed crop material is then moved through an opening to a conveyor in feeder house 1076 toward feed accelerator 1078, which accelerates the severed crop material into thresher 1070. The severed crop material is threshed by rotor 1072 rotating the crop against concaves 1084. The threshed crop material is moved by a separator rotor in separator 1086 where a portion of the residue is moved by discharge beater 1026 toward the residue subsystem 1038. The portion of residue transferred to the residue subsystem 1308 is chopped by residue chopper 1040 and spread on the field by residue spreader 1042.

Grain falls to cleaning subsystem 1018. Chaffer 1022 separates some larger pieces of material other than grain (MOG) from the grain, and sieve 1024 separates some of finer pieces of MOG from the grain. The grain then falls to a conveyor (e.g., an auger, etc.) that moves the grain to an inlet end of grain elevator 1030, and the grain elevator 1030 moves the grain upwards, depositing the grain in grain tank 1032. Residue is removed from the cleaning subsystem 1018 by airflow generated by one or more cleaning fans 1020. Cleaning fans 1020 direct air along an airflow path upwardly through the sieves and chaffers. The airflow carries residue rearwardly in harvester 1006 toward the residue handling subsystem 1038 where it is chopped by residue chopper 1040 and spread on the field by residue spreader 1042.

Tailings elevator 1028 returns tailings to thresher 1010 where the tailings are re-threshed. Alternatively, the tailings also can be passed to a separate re-threshing mechanism by a tailings elevator or another transport device where the tailings are re-threshed as well.

Harvester 1006 can include a variety of sensors, some of which are illustrated in FIG. 7, such as one or more ground speed sensors 1046, one or more geographic position sensors 1063, and one or more imaging devices, such as cameras, 1002.

Ground speed sensors 1046 sense the travel speed of harvester 1006 over the ground. Ground speed sensors 1046 can sense the travel speed of the harvester 1006 by sensing the speed of rotation of the ground engaging traction elements 1044 or 1045, or both, a drive shaft, an axle, or other components. In some instances, the travel speed can be sensed using a positioning system (e.g., geographic position sensors 1063), such as a global positioning system (GPS), a dead reckoning system, a long-range navigation (LORAN) system, a Doppler speed sensor, or a wide variety of other systems or sensors that provide an indication of travel speed. Ground speed sensors 1046 can also include direction sensors such as a compass, a magnetometer, a gravimetric sensor, a gyroscope, GPS derivation, to determine the direction of travel in two or three dimensions in combination with the speed. This way, when harvester 1006 is on a slope, the orientation of harvester 1006 relative to the slope is known. For example, an orientation of harvester 1006 could include ascending, descending or transversely travelling the slope.

Geographic position sensors 1063 illustratively sense or detect the geographic position or location of harvester 1006. Geographic position sensors 1063 can include, but are not limited to, a global navigation satellite system (GNSS) receiver that receives signals from a GNSS satellite transmitter. Geographic position sensors 1063 can also include a real-time kinematic (RTK) component that is configured to enhance the precision of position data derived from the GNSS signal. Geographic position sensors 1063 can include a dead reckoning system, a cellular triangulation system, or any of a variety of other geographic position sensors.

Imaging devices 1002 capture images indicative of various crop harvest characteristics, such as such an agricultural characteristic (e.g., soil moisture or other ground conditions), a machine characteristic (e.g., harvester operating conditions or parameters), a performance characteristic (e.g., chopping quality, residue spread quality, processing level, grain loss, etc.), and/or a crop characteristic (e.g., down crop or standing crop, crop moisture, grain quality (good grain or bad grain), crop state, etc.), among others. Imaging devices 1002 are examples of imaging devices or cameras 102. As shown, imaging devices 1002 can be located at various positions on harvester 1006 and disposed to look at or observe various locations including locations around (e.g., ahead of, behind, etc.) harvester 1006 and locations internal to harvester 1006. The example locations of imaging devices 1002 are examples only. In other examples, imaging devices 1002 can be, additionally, or alternatively, disposed at various other locations including the other locations of imaging devices (e.g., 102) described herein.

As can be seen in FIG. 7, an imaging device 1002 is disposed to observe rearwardly of harvester 1006, such as to detect residue performance such as residue spread quality, chopping quality, as well as other residue performance characteristics.

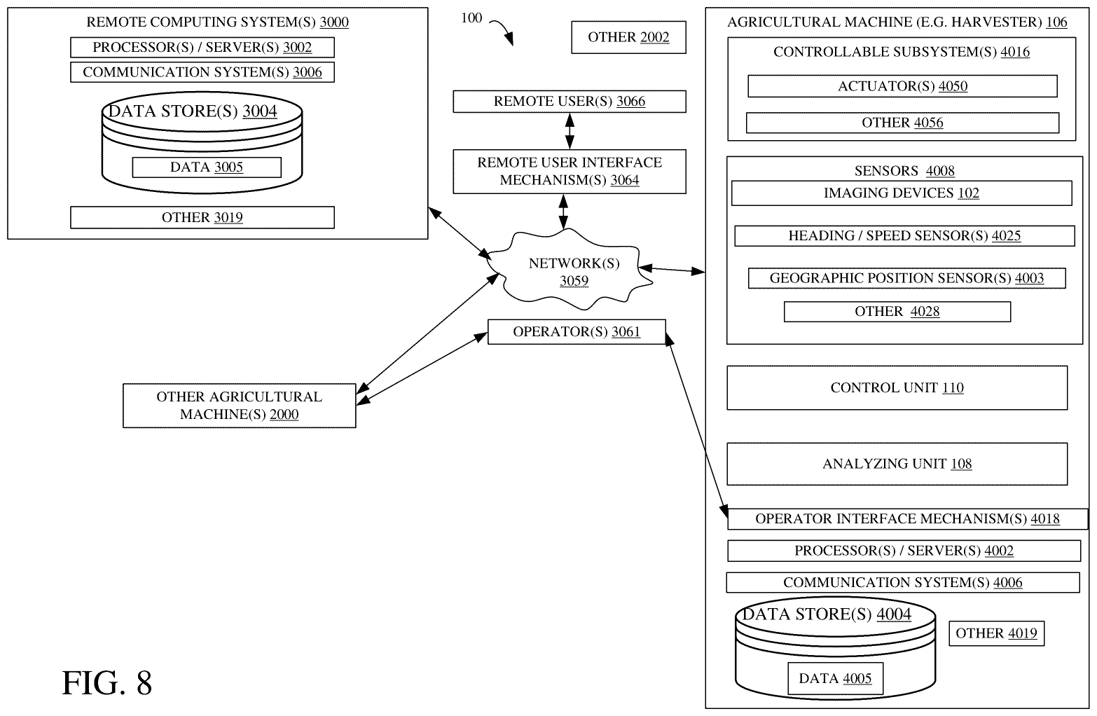

FIG. 8 is a block diagram showing another example of crop harvest characteristic monitoring system 100 (hereinafter also referred to as system 100). System 100 includes harvester 106. One example of harvester 106 is also shown as harvester 1006 in FIG. 7. System 100 also includes one or more remote computing systems 3000, one or more networks 3059, one or more remote user interface mechanisms 3064, one or more other machines 2000, and can include a variety of other items 2002 as well. Other agricultural machines 2000 can include any of a variety of other agricultural machines, such as other agricultural machines (e.g., tillage machines, spraying machines, planting machines, etc.) that perform other agricultural operations (e.g., tillage operations, spraying operations, planting operations, etc.) that may be subsequent to the harvesting operation performed by harvester 106. Examples of other agricultural machines and other agricultural operations have been previously described.

As shown in FIG. 8, harvester 106, itself, illustratively includes one or more processors or servers 4002, one or more data stores 4004, one or more communication systems 4006, one or more sensors 4008, analyzing unit 108, control unit 110, one or more controllable subsystems 4016, one or more operator interface mechanisms 4018, and can include various other items and functionality 4019 as well.

Remote computing systems 3000, as illustrated, include one or more processors or servers 3002, one or more data stores 3004, one or more communication systems 3006, and can include various other items and functionality 3019.

Data stores 3004 and data stores 4004 each store a variety of data (generally indicated data 3005 and data 4005 respectively), such as the various data described herein. Additionally, data 305 can include computer executable (readable) instructions that are executable by one or more processors or servers 3002 to implement other items or functionalities of system 100, including other items of remote computing systems 3000. Additionally, data 4005 can include computer executable (readable) instructions that are executable by one or more processors or servers 4002 to implement other items or functionalities of system 100, including other items or functionalities of harvester 106. It will be understood that data stores 3004 and data stores 4004 can include different forms of data stores, for instance both volatile data stores (e.g., Random Access Memory (RAM)) and non-volatile data stores (e.g., Read Only Memory (ROM), hard drives, solid state drives, etc.). Though not shown in FIG. 8, it will be understood that each other agricultural machine 2000 can also include data stores similar to or the same as data stores 3004 or 4004 that store data similar to or the same as data 3005 or 4005.

Sensors 4008 can include one or more imaging devices 102, one or more heading/speed sensors 4025, one or more geographic position sensors 4003, one or and can include various other sensors 4028 as well. The sensor data (e.g., images, signals, etc.) generated by sensors 4008 can be communicated to remote computing systems 3000, to other agricultural machines 2000, and to other items of harvester 106.

Heading/speed sensors 4025 detect a heading characteristic (e.g., travel direction) or speed characteristic (e.g., travel speed, acceleration, deceleration, etc.), or both, of harvester 106. This can include sensors that sense the movement (e.g., rotation) of ground-engaging elements (e.g., 144, 145) or movement of components (e.g., axles) coupled to the ground engaging elements or other elements, or can utilize signals received from other sources, such as geographic position sensors. Thus, while heading/speed sensors 4025 as described herein are shown as separate from geographic position sensors 4003, in some examples, machine heading/speed is derived from signals received from geographic position sensors 4003 and subsequent processing. In other examples, heading/speed sensors 4025 are separate sensors and do not utilize signals received from other sources. One example of heading/speed sensors 4025 are sensors 1046 shown in FIG. 7.

Geographic position sensors 4003 illustratively sense or detect the geographic position or location of agricultural harvester 106. Geographic position sensors 403 can include, but are not limited to, a global navigation satellite system (GNSS) receiver that receives signals from a GNSS satellite transmitter. Geographic position sensors 4003 can also include a real-time kinematic (RTK) component that is configured to enhance the precision of position data derived from the GNSS signal. Geographic position sensors 4003 can include a dead reckoning system, a cellular triangulation system, or any of a variety of other geographic position sensors. One example of geographic position sensors 4003 are geographic position sensors 1063 shown in FIG. 7.

Imaging devices, or cameras, 102 have been previously described. One example of imaging devices 102 are imaging devices 1002 shown in FIG. 7.

Sensors 4008 can also include various other types of sensors 4028.

Analyzing unit 108 has been previously described herein. Control unit 110 has been previously described herein and can, among other things (as previously described), generate control signals to control one or more components of system 100, such as one or more components of harvester 106, such as controllable subsystems 4016 (e.g., to adjust operational settings of the controllable subsystems 4016), interface mechanisms 4018, and communication system 4006.

As shown, controllable subsystems 4016 include one or more actuators 4050 as well as various other items 4056. Actuators 450 include a variety of different types of actuators that control operational settings of one or more components of harvester 106. Actuators 4050 can include actuators that control the position (e.g., height, depth, or spacing) or orientation (e.g., pitch, roll, yaw, etc.) of components of harvester 106 as well as actuators that control a speed of movement (e.g., speed of rotation, speed of reciprocation, etc.) of components of harvester 106. Actuators 450 can include, without limitation, motors, valves, pumps, hydraulic actuators (e.g., hydraulic cylinders, etc.), pneumatic actuators (e.g., pneumatic cylinders, etc.), electric actuators (e.g., linear actuators, etc.), as well as various other types of actuators. Some examples of actuators 4050 have been previously shown and described herein, such as actuator 506, actuator 508, actuator 512, actuators 1007, as well as other actuators described herein. While not shown in FIG. 8, it will be understood that each other agricultural machine 2000 can include one or more actuators, similar to or the same as actuators 4050, that are controllable to adjust operational settings of the other agricultural machine 2000, such as by control unit 110 when control unit 110 is disposed on the other agricultural machine 2000.

Communication systems 4006 are used to communicate between components of harvester 106, or with other items of system 100, such as remote computing systems 3000, other agricultural machines 2000, or user interface mechanisms 3064, or a combination thereof. Communication systems 3006 are used to communicate between components of a remote computing system 3000 or with other items of system 100, such as harvester 106, other agricultural machines 2000 other remote computing systems 3000, or user interface mechanisms 3064, or a combination thereof.

Communication systems 3006 and 4006 can both include one or more of wired communication circuitry and wireless communication circuitry, as well as wired and wireless communication components. In some examples, communication systems 3006 and 4006 can include one or more of a system for communicating over various networks, such as a communication system for communicating over the Internet, a cellular communication system, a system for communicating over a wide area network or a local area network, a system for communicating over a controller area network (CAN), such as a CAN bus, a system for communicating over a controller area network flexible data-rate (CAN-FD), such as a CAN-FD bus, a system for communication over a near field communication network, a system for communicating over ethernet, or a communication system configured to communicate over any of a variety of other networks. Communication systems 3006 and 4006 can both also include a system that facilitates downloads or transfers of information to and from a secure digital (SD) card or a universal serial bus (USB) card, or both. Communication systems 306 and 406 can both utilize network 3059. Networks 3059 can be any of a wide variety of different types of networks such as the Internet, a cellular network, a wide area network (WAN), a local area network (LAN), a controller area network (CAN), a controller area network flexible data-rate (CAN-FD), a near-field communication network, ethernet, or any of a wide variety of other networks.

While not shown in FIG. 8, it will be understood that each other agricultural machine 2000 can include communication systems similar to or the same as communications systems 4006 or 3006.

FIG. 8 shows that one or more operators 3061 can operate harvester 106 or other agricultural machines 2000. Operators 361 interact with operator interface mechanisms, such as operator interface mechanism 4018. In some examples, operator interface mechanisms 4018 can include joysticks, levers, a steering wheel, linkages, pedals, buttons, wireless devices (e.g., mobile computing devices, etc.), dials, keypads, a display device (including a display screen), user actuatable elements (such as icons, buttons, etc.) on a display device, a microphone and speaker (where speech recognition and speech synthesis are provided), among a wide variety of other types of control devices. Where a touch sensitive display system is provided, operators 3061 can interact with operator interface mechanisms 4018 using touch gestures. Additionally, at least some of the operator interface mechanisms 4018 can be used to present (e.g., display, audible presentation, haptic presentation, etc.) various information. The examples described above are provided as illustrative examples and are not intended to limit the scope of the present disclosure. Consequently, other types of operator interface mechanisms 4018 can be used and are within the scope of the present disclosure. One example of an operator interface mechanism 4018 is interface 550.

Additionally, in some examples, some operator interface mechanisms 4018 can be separate from (or separable from), but communicatively coupled to harvester 106.

While not shown in FIG. 8, it will be understood that each other agricultural machine 2000 can include operator interface mechanisms, similar to or the same as operator interface mechanisms 4018, and interactable by operators 3061.

FIG. 8 also shows remote users 3066 interacting with harvester 106, other agricultural machines 2000, and remote computing systems 3000 through user interface mechanisms 3064 over networks 3059. In some examples, user interface mechanisms 364 can include joysticks, levers, a steering wheel, linkages, pedals, buttons, wireless devices (e.g., mobile computing devices, etc.), dials, keypads, a display device (including a display screen), user actuatable elements (such as icons, buttons, etc.) on a display device, a microphone and speaker (where speech recognition and speech synthesis are provided), among a wide variety of other types of control devices. Where a touch sensitive display system is provided, the users 3066 can interact with user interface mechanisms 3064 using touch gestures. Additionally, at least some of the user interface mechanisms 3064 can be used to present (e.g., display, audible presentation, haptic presentation, etc.) various information. The examples described above are provided as illustrative examples and are not intended to limit the scope of the present disclosure. Consequently, other types of user interface mechanisms 364 can be used and are within the scope of the present disclosure. One example of a user interface mechanism 3064 is interface 550.

Remote computing systems 3000 can be a wide variety of different types of systems, or combinations thereof. For example, remote computing systems 3000 can be in a remote server environment. Further, remote computing systems 3000 can be remote computing systems, such as mobile devices, a remote network, a farm manager system, a vendor system, or a wide variety of other remote systems. In one example, harvester 106 and other agricultural machines 2000 can be controlled remotely by remote computing systems 3000 or by remote users 3066, or both. In some examples, operators 3061 are on-board (e.g., in an operator compartment, such as a cab) of harvester 106 or other agricultural machines 2000. In some examples, operators 3061 are remote from the harvester 106 or the other agricultural machines 2000 and control the harvester 106 or the agricultural machines 2000 through one or more interface mechanisms (e.g., 4018) which are remote from the machines but operatively coupled (e.g., communicatively coupled, such as over networks 3059) to the machines (e.g., 106, 2000).

As previously described, items in system 100 can be distributed in various ways. For example, items in system 100 can be distributed in various ways, including ways that differ from the example shown in FIG. 8. For example, but not by limitation, control unit 110, shown in FIG. 8 as being disposed on harvester 106, can be located elsewhere, such as at one or more remote computing systems 3000 or on an other agricultural machine 2000. In yet other examples, control unit 110 can be distributed across multiple items of system 100, including for example, across a harvester 106, a remote computing system 3000, and an other agricultural machine 2000. In yet other examples, each of the harvester 106, a remote computing system 3000, and an agricultural machine 2000 can include a respective control unit 110. Further, for example, but not by limitation, analyzing unit 108, shown in FIG. 8 as being disposed on harvester 106, can be located elsewhere, such as at one or more remote computing systems 3000 or on an other agricultural machine 2000. In yet other examples, analyzing unit 108 can be distributed across multiple items of system 100, including for example, across a harvester 106, a remote computing system 3000, and an other agricultural machine 2000. In yet other examples, each of the harvester 106, a remote computing system 3000, and an agricultural machine 2000 can include a respective analyzing unit 108.

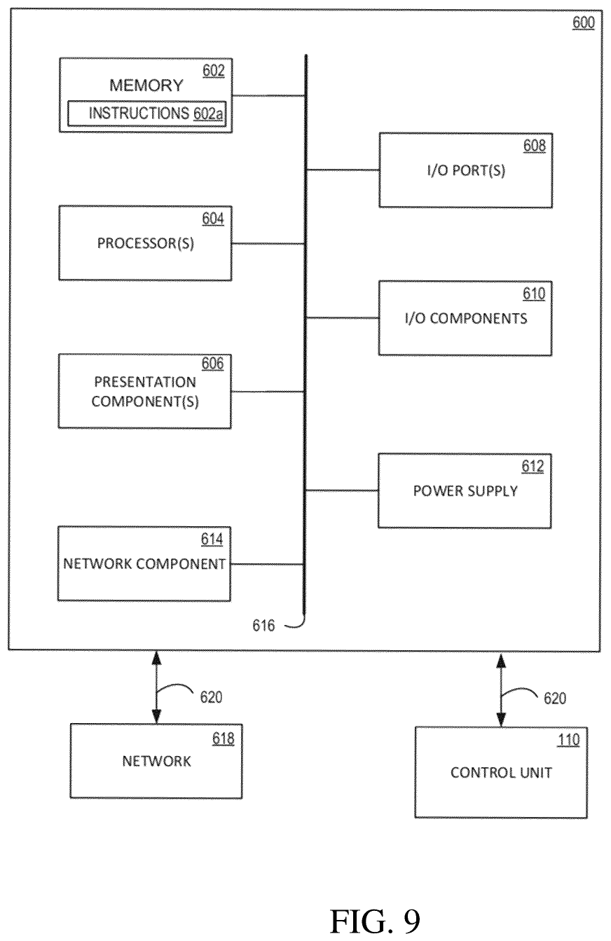

With reference now to FIG. 9, a block diagram of a computing device 600 suitable for implementing various aspects of the disclosure as described. For example, in operation, the computing device 600 is operable with the control unit 110 to control operation of a harvester 106 as describe in more detail herein. FIG. 9 and the following discussion provide a brief, general description of a computing environment in/on which one or more or the implementations of one or more of the methods and/or system set forth herein may be implemented. The operating environment of FIG. 9 is merely an example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, mobile consoles, tablets, media players, and the like), multiprocessor systems, consumer electronics, mini computers, mainframe computers, distributed computing environments that include any of the above systems or devices, and the like.

Although not required, implementations are described in the general context of “computer readable instructions” executed by one or more computing devices. Computer readable instructions may be distributed via computer readable media (discussed below). Computer readable instructions may be implemented as program modules, such as functions, objects, Application Programming Interfaces (APIs), data structures, and the like, which perform particular tasks or implement particular abstract data types. Typically, the functionality of the computer readable instructions may be combined or distributed as desired in various environments.

In some examples, the computing device 600 includes a memory 602, one or more processors 604, and one or more presentation components 606. The disclosed examples associated with the computing device 600 are practiced by a variety of computing devices, including personal computers, laptops, smart phones, mobile tablets, hand-held devices, consumer electronics, specialty computing devices, etc. Distinction is not made between such categories as “workstation,” “server,” “laptop,” “hand-held device,” etc., as all are contemplated within the scope of FIG. 9 and the references herein to a “computing device.” The disclosed examples are also practiced in distributed computing environments, where tasks are performed by remote-processing devices that are linked through a communications network Further, while the computing device 600 is depicted as a single device, in one example, multiple computing devices work together and share the depicted device resources. For instance, in one example, the memory 602 is distributed across multiple devices, the processor(s) 604 provided are housed on different devices, and so on.

In one example, the memory 602 includes any of the computer-readable media discussed herein. In one example, the memory 602 is used to store and access instructions 602a configured to carry out the various operations disclosed herein. In some examples, the memory 602 includes computer storage media in the form of volatile and/or nonvolatile memory, removable or non-removable memory, data disks in virtual environments, or a combination thereof. In one example, the processor(s) 604 includes any quantity of processing units that read data from various entities, such as the memory 602 or input/output (I/O) components 610. Specifically, the processor(s) 604 are programmed to execute computer-executable instructions for implementing aspects of the disclosure. In one example, the instructions 602a are performed by the processor 604, by multiple processors within the computing device 600, or by a processor external to the computing device 600. In some examples, the processor(s) 604 are programmed to execute instructions such as those illustrated in the flow charts discussed herein and depicted in the accompanying drawings.

In other implementations, the computing device 600 may include additional features and/or functionality. For example, the computing device 600 may also include additional storage (e.g., removable and/or non-removable) including, but not limited to, magnetic storage, optical storage, and the like. Such additional storage is illustrated in FIG. 9 by the memory 602. In one implementation, computer readable instructions to implement one or more implementations provided herein may be in the memory 602 as described herein. The memory 602 may also store other computer readable instructions to implement an operating system, an application program and the like. Computer readable instructions may be loaded in the memory 602 for execution by the processor(s) 604, for example.

The presentation component(s) 606 present data indications to an operator or to another device. In one example, the presentation components 606 include a display device, speaker, printing component, vibrating component, etc. One skilled in the art will understand and appreciate that computer data is presented in a number of ways, such as visually in a graphical user interface (GUI), audibly through speakers, wirelessly between the computing device 600, across a wired connection, or in other ways. In one example, the presentation component(s) 606 are not used when processes and operations are automated that a need for human interaction is lessened or not needed. I/O ports 608 allow the computing device 600 to be logically coupled to other devices including the I/O components 610, some of which is built in. Implementations of the I/O components 610 include, for example but without limitation, a microphone, keyboard, mouse, joystick, pen, game pad, satellite dish, scanner, printer, wireless device, camera, etc.

The computing device 600 includes a bus 616 that directly or indirectly couples the following devices: the memory 602, the one or more processors 604, the one or more presentation components 606, the input/output (I/O) ports 608, the I/O components 610, a power supply 612, and a network component 614. The computing device 600 should not be interpreted as having any dependency or requirement related to any single component or combination of components illustrated therein. The bus 616 represents one or more busses (such as an address bus, data bus, or a combination thereof). Although the various blocks of FIG. 9 are shown with lines for the sake of clarity, some implementations blur functionality over various different components described herein.

The components of the computing device 600 may be connected by various interconnects. Such interconnects may include a Peripheral Component Interconnect (PCI), such as PCI Express, a Universal Serial Bus (USB), firewire (IEEE 1394), an optical bus structure, and the like. In another implementation, components of the computing device 600 may be interconnected by a network. For example, the memory 602 may be comprised of multiple physical memory units located in different physical locations interconnected by a network.

In some examples, the computing device 600 is communicatively coupled to a network 618 using the network component 614. In some examples, the network component 614 includes a network interface card and/or computer-executable instructions (e.g., a driver) for operating the network interface card. In one example, communication between the computing device 600 and other devices occurs using any protocol or mechanism over a wired or wireless connection 620. In some examples, the network component 614 is operable to communicate data over public, private, or hybrid (public and private) connections using a transfer protocol, between devices wirelessly using short range communication technologies (e.g., near-field communication (NFC), Bluetooth® branded communications, or the like), or a combination thereof.

The connection 620 may include, but is not limited to, a modem, a Network Interface Card (NIC), an integrated network interface, a radio frequency transmitter/receiver, an infrared port, a USB connection or other interfaces for connecting the computing device 600 to other computing devices. The connection 620 may transmit and/or receive communication media.

Although described in connection with the computing device 600, examples of the disclosure are capable of implementation with numerous other general-purpose or special-purpose computing system environments, configurations, or devices. Implementations of well-known computing systems, environments, and/or configurations that are suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, VR devices, holographic device, and the like. Such systems or devices accept input from the user in any way, including from input devices such as a keyboard or pointing device, via gesture input, proximity input (such as by hovering), and/or via voice input.

Implementations of the disclosure, such as controllers or monitors, are described in the general context of computer-executable instructions, such as program modules, executed by one or more computers or other devices in software, firmware, hardware, or a combination thereof. In one example, the computer-executable instructions are organized into one or more computer-executable components or modules. Generally, program modules include, but are not limited to, routines, programs, objects, components, and data structures that perform particular tasks or implement particular abstract data types. In one example, aspects of the disclosure are implemented with any number and organization of such components or modules. For example, aspects of the disclosure are not limited to the specific computer-executable instructions or the specific components or modules illustrated in the figures and described herein. Other examples of the disclosure include different computer-executable instructions or components having more or less functionality than illustrated and described herein. In implementations involving a general-purpose computer, aspects of the disclosure transform the general-purpose computer into a special-purpose computing device when configured to execute the instructions described herein.

By way of example and not limitation, computer readable media comprises computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. In one example, computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium used to store information for access by a computing device. In contrast, communication media typically embody computer readable instructions, data structures, program modules, or the like in a modulated data signal such as a carrier wave or other transport mechanism and include any information delivery media.

The present discussion has mentioned processors and servers. In some examples, the processors and servers include computer processors with associated memory and timing circuitry, not separately shown. They are functional parts of the systems or devices to which they belong and are activated by and facilitate the functionality of the other components or items in those systems.

Also, a number of user interface displays have been discussed. The displays can take a wide variety of different forms and can have a wide variety of different user actuatable operator interface mechanisms disposed thereon. For instance, user actuatable operator interface mechanisms can include text boxes, check boxes, icons, links, drop-down menus, search boxes, etc. The user actuatable operator interface mechanisms can also be actuated in a wide variety of different ways. For instance, they can be actuated using operator interface mechanisms such as a point and click device, such as a track ball or mouse, hardware buttons, switches, a joystick or keyboard, thumb switches or thumb pads, etc., a virtual keyboard or other virtual actuators. In addition, where the screen on which the user actuatable operator interface mechanisms are displayed is a touch sensitive screen, the user actuatable operator interface mechanisms can be actuated using touch gestures. Also, user actuatable operator interface mechanisms can be actuated using speech commands using speech recognition functionality. Speech recognition can be implemented using a speech detection device, such as a microphone, and software that functions to recognize detected speech and execute commands based on the received speech.

A number of data stores have also been discussed. It will be noted the data stores can each be broken into multiple data stores. In some examples, one or more of the data stores can be local to the systems accessing the data stores, one or more of the data stores can all be located remote form a system utilizing the data store, or one or more data stores can be local while others are remote. All of these configurations are contemplated by the present disclosure.

Also, the figures show a number of blocks with functionality ascribed to each block. It will be noted that fewer blocks can be used to illustrate that the functionality ascribed to multiple different blocks is performed by fewer components. Also, more blocks can be used illustrating that the functionality can be distributed among more compoents. In different examples, some functionality can be added, and some can be removed.

It will be noted that the above discussion has described a variety of different systems, units, components, and interactions. It will be appreciated that any or all of such systems, units, components, and interactions can be implemented by hardware items, such as one or more processors, one or more processors executing computer executable instructions stored in memory, memory, or other processing components, some of which are described elsewhere herein, that perform the functions associated with those systems, units, components, and interactions. In addition, any or all of the systems, units, components, and interactions can be implemented by software that is loaded into a memory and is subsequently executed by one or more processors or one or more servers or other computing component(s), as described elsewhere herein. Any or all of the systems, units, components, and interactions can also be implemented by different combinations of hardware, software, firmware, etc., some examples of which are described elsewhere herein. These are some examples of different structures that can be used to implement any or all of the systems, units components, and interactions described above. Other structures can be used as well.

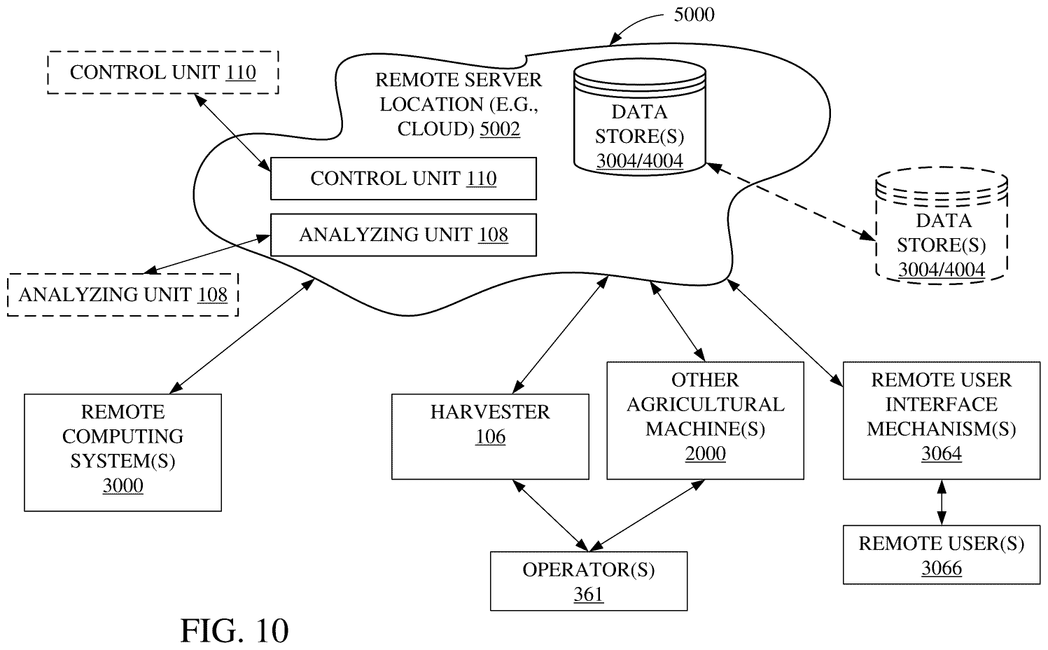

FIG. 10 is a block diagram of a remote server architecture 5000. FIG. 10, also shows harvester 106, one or more remote computing systems 300, one or more agricultural machines 2000, and one or more remote user interface mechanisms 3064 in communication with the remote server environment. The harvester 106, remote computing systems 3000, agricultural machines 2000, and remote user interface mechanisms 3064 communicate with elements in a remote server architecture 5000. In some examples, remote server architecture 5000 provides computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network and can be accessible through a web browser or any other computing component. Software or components shown in previous figures as well as data associated therewith, can be stored on servers at a remote location. The computing resources in a remote server environment can be consolidated at a remote data center location, or the computing resources can be dispersed to a plurality of remote data centers. Remote server infrastructures can deliver services through shared data centers, even though the services appear as a single point of access for the user. Thus, the components and functions described herein can be provided from a remote server at a remote location using a remote server architecture. Alternatively, the components and functions can be provided from a server, or the components and functions can be installed on client devices directly, or in other ways.

In the example shown in FIG. 10, some items are similar to those shown in previous figures and those items are similarly numbered. FIG. 10 specifically shows that control unit 110, analyzing unit 108, data stores 3004, or data stores 4004, or a combination thereof, can be located at a server location 5002 that is remote from the harvester 106, remote computing systems 3000, agricultural machines 2000, and remote user interface mechanisms 3064. Therefore, in the example shown in FIG. 10, harvester 106, remote computing systems 3000, agricultural machines 2000, and remote user interface mechanisms 3064 access systems through remote server location 5002. In other examples, various other items can also be located at server location 5002, such as various other items of system 100.

FIG. 10 also depicts another example of a remote server architecture. FIG. 10 shows that some elements of previous figures can be disposed at a remote server location 5002 while others can be located elsewhere. By way of example, one or more of data store(s) 3004 and 4004 can be disposed at a location separate from location 5002 and accessed via the remote server at location 5002. Similarly, control unit 110 or analyzing unit 108, or both, can be disposed at a location separate from location 1002 and accessed via the remote server at location 1002. Regardless of where the elements are located, the elements can be accessed directly by harvester 106, remote computing systems 3000, agricultural machines 2000, and remote user interface mechanisms 3064 through a network such as a wide area network or a local area network; the elements can be hosted at a remote site by a service; or the elements can be provided as a service or accessed by a connection service that resides in a remote location. Also, data can be stored in any location, and the stored data can be accessed by, or forwarded to, operators, users, or systems. For instance, physical carriers can be used instead of, or in addition to, electromagnetic wave carriers. In some examples, where wireless telecommunication service coverage is poor or nonexistent, another machine, such as a fuel truck or other mobile machine or vehicle, can have an automated, semi-automated or manual information collection system. As a mobile machine (e.g., harvester 106, machine 2000) comes close to the machine containing the information collection system, such as a fuel truck prior to fueling, or other mobile machine or vehicle, the information collection system collects the information from the mobile machine (e.g., harvester 106, machine 200) using any type of ad-hoc wireless connection. The collected information can then be forwarded to another network when the machine containing the received information reaches a location where wireless telecommunication service coverage or other wireless coverage is available. For instance, a fuel truck, can enter an area having wireless communication coverage when traveling to a location to fuel other machines or when at a main fuel storage location. Other mobile machines or vehicles can enter an area having wireless communication coverage when traveling to other locations or when at another location. All of these architectures are contemplated herein. Further, the information can be stored on a mobile machine (e.g., harvester 106, machine 2000) until the mobile machine enters an area having wireless communication coverage. The mobile machine (e.g., harvester 106, machine 2000), itself, can send the information to another network.

It will also be noted that the elements of previous figures, or portions thereof, can be disposed on a wide variety of different devices. One or more of those devices can include an on-board computer, an electronic control unit, a display unit, a server, a desktop computer, a laptop computer, a tablet computer, or other mobile device, such as a palm top computer, a cell phone, a smart phone, a multimedia player, a personal digital assistant, etc.

In some examples, remote server architecture 5000 can include cybersecurity measures. Without limitation, these measures can include encryption of data on storage devices, encryption of data sent between network nodes, authentication of people or processes accessing data, as well as the use of ledgers for recording metadata, data, data transfers, data accesses, and data transformations. In some examples, the ledgers can be distributed and immutable (e.g., implemented as blockchain).

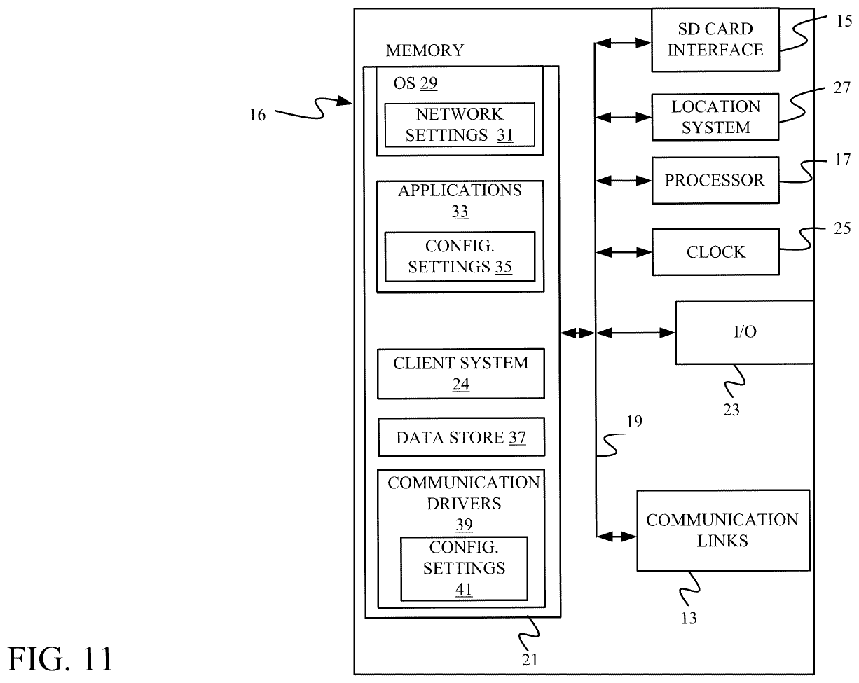

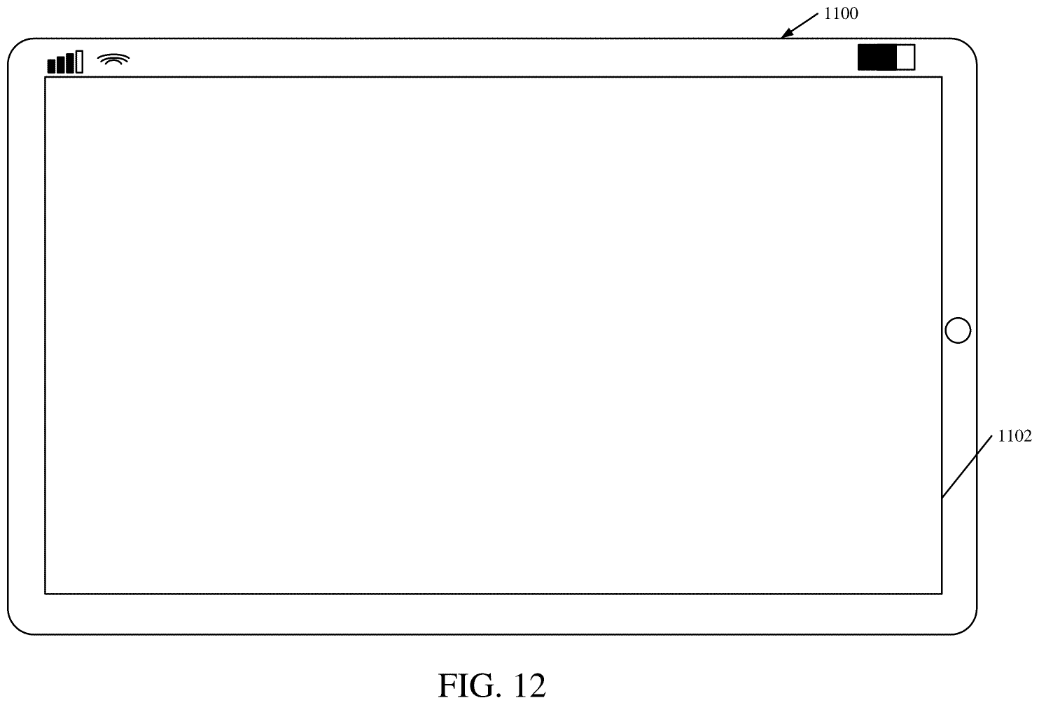

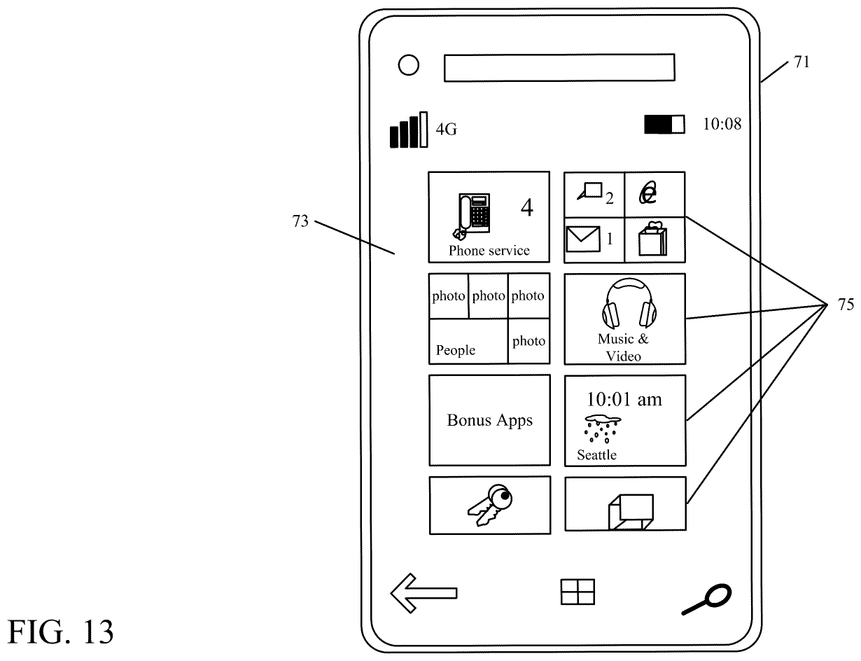

FIG. 11 is a simplified block diagram of one illustrative example of a handheld or mobile computing device that can be used as a user's or client's handheld device 16, in which the present system (or parts of it) can be deployed. For instance, a mobile device can be deployed in the operator compartment of a mobile machine (e.g., harvester 106, machine 2000) or can be communicably coupled to a mobile machine (e.g., harvester 106, machine 2000) for use in generating, processing, or displaying the information and outputs discussed above. FIGS. 12 and 13 are examples of handheld or mobile devices.

FIG. 11 provides a general block diagram of the components of a client device 16 that can run some components shown in previous figures, that interacts with them, or both. In the device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from other figures) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, client system 24, data store 37, communication drivers 39, and communication configuration settings 41. Memory 21 can include all types of tangible volatile and non-volatile computer-readable memory devices. Memory 21 can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

FIG. 12 shows one example in which device 16 is a tablet computer 1100. In FIG. 12, computer 1100 is shown with user interface display screen 1102. Screen 1102 can be a touch screen or a pen-enabled interface that receives inputs from a pen or stylus. Tablet computer 1100 can also use an on-screen virtual keyboard. Of course, computer 1100 can also be attached to a keyboard or other user input device through a suitable attachment mechanism, such as a wireless link or USB port, for instance. Computer 1100 can also illustratively receive voice inputs as well.

FIG. 13 is similar to FIG. 12 except that the device is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

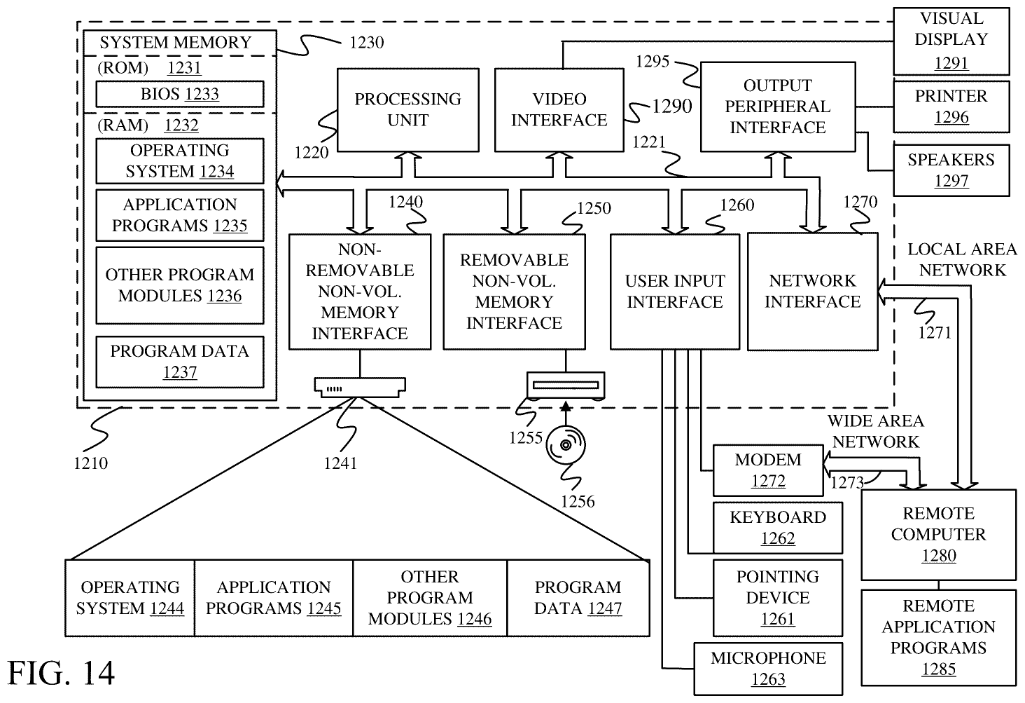

FIG. 14 is one example of a computing environment in which elements of previous figures described herein can be deployed. With reference to FIG. 14, an example system for implementing some embodiments includes a computing device in the form of a computer 1210 programmed to operate as discussed above. Components of computer 1210 can include, but are not limited to, a processing unit 1220 (which can comprise processors or servers from previous figures), a system memory 1230, and a system bus 1221 that couples various system components including the system memory to the processing unit 1220. The system bus 1221 can be any of several types of bus structures including a memory bus or memory controller, a peripheral bus, and a local bus using any of a variety of bus architectures. Memory and programs described with respect to previous figures described herein can be deployed in corresponding portions of FIG. 14.

Computer 1210 typically includes a variety of computer readable media. Computer readable media can be any available media that can be accessed by computer 1210 and includes both volatile and nonvolatile media, removable and non-removable media. By way of example, and not limitation, computer readable media can comprise computer storage media and communication media. Computer storage media is different from, and does not include, a modulated data signal or carrier wave. Computer readable media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1210. Communication media can embody computer readable instructions, data structures, program modules or other data in a transport mechanism and includes any information delivery media. The term “modulated data signal” means a signal that has one or more of its characteristics set or changed in such a manner as to encode information in the signal.

The system memory 1230 includes computer storage media in the form of volatile and/or nonvolatile memory or both such as read only memory (ROM) 1231 and random access memory (RAM) 1232. A basic input/output system 1233 (BIOS), containing the basic routines that help to transfer information between elements within computer 1210, such as during start-up, is typically stored in ROM 1231. RAM 1232 typically contains data or program modules or both that are immediately accessible to and/or presently being operated on by processing unit 1220. By way of example, and not limitation, FIG. 14 illustrates operating system 1234, application programs 1235, other program modules 1236, and program data 1237.

The computer 1210 can also include other removable/non-removable volatile/nonvolatile computer storage media. By way of example only, FIG. 14 illustrates a hard disk drive 1241 that reads from or writes to non-removable, nonvolatile magnetic media, an optical disk drive 1255, and nonvolatile optical disk 1256. The hard disk drive 1241 is typically connected to the system bus 1221 through a non-removable memory interface such as interface 1240, and optical disk drive 1255 are typically connected to the system bus 1221 by a removable memory interface, such as interface 1250.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), quantum computers, etc.

The drives and their associated computer storage media discussed above and illustrated in FIG. 14 provide storage of computer readable instructions, data structures, program modules and other data for the computer 1210. In FIG. 14, for example, hard disk drive 1241 is illustrated as storing operating system 1244, application programs 1245, other program modules 1246, and program data 1247. Note that these components can either be the same as or different from operating system 1234, application programs 1235, other program modules 1236, and program data 1237.

A user can enter commands and information into the computer 1210 through input devices such as a keyboard 1262, a microphone 1263, and a pointing device 1261, such as a mouse, trackball or touch pad. Other input devices (not shown) can include a joystick, game pad, satellite dish, scanner, or the like. These and other input devices are often connected to the processing unit 1220 through a user input interface 1260 that is coupled to the system bus, but can be connected by other interface and bus structures. A visual display 1291 or other type of display device is also connected to the system bus 1221 via an interface, such as a video interface 1290. In addition to the monitor, computers can also include other peripheral output devices such as speakers 1297 and printer 1296, which can be connected through an output peripheral interface 1295.

The computer 1210 is operated in a networked environment using logical connections (such as a controller area network-CAN, local area network-LAN, or wide area network WAN) to one or more remote computers, such as a remote computer 1280.

When used in a LAN networking environment, the computer 1210 is connected to the LAN 1271 through a network interface or adapter 1270. When used in a WAN networking environment, the computer 1210 typically includes a modem 1272 or other means for establishing communications over the WAN 1273, such as the Internet. In a networked environment, program modules can be stored in a remote memory storage device. FIG. 14 illustrates, for example, that remote application programs 1285 can reside on remote computer 1280.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of the claims.

While various spatial and directional terms, including but not limited to top, bottom, lower, mid, lateral, horizontal, vertical, front and the like are used to describe the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and 16 “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Various operations of implementations are provided herein. In one implementation, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each implementation provided herein.

Any range or value given herein can be extended or altered without losing the effect sought, as will be apparent to the skilled person.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

As used in this application, the terms “component,” “module,” “system,” “interface,” and the like are generally intended to refer to a computer-related entity, either hardware, a combination of hardware and software, software, or software in execution. For example, a component may be, but is not limited to being, a process running on a processor, a processor, an object, an executable, a thread of execution, a program and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device, carrier or media. Of course, those skilled in the art will recognize many modifications may be made to this configuration without departing from the scope or spirit of the claimed subject matter.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of the systems and methods described herein. It is intended to include all such modifications and alterations in so far as they come within the scope of the appended claims or the equivalents thereof.

What is claimed is:

1. An agricultural system comprising:
an imaging device configured to capture an image indicative of a characteristic;
one or more processors; and
memory storing instructions executable by the one or more processors that, when executed by the one or more processors, cause the agricultural system to:
determine, based, at least, on the image, a probability value corresponding to the image, the probability value indicating a probability that the characteristic indicated by the image corresponds to a characteristic level category of a plurality of characteristic level categories; and
control an agricultural machine based, at least, on the probability value.

2. The agricultural system of claim 1, wherein the characteristic comprises one of an agricultural characteristic, a machine characteristic, a performance characteristic, or a crop characteristic.

3. The agricultural system of claim 2, wherein the characteristic comprises a residue performance characteristic.

4. The agricultural system of claim 1, wherein the instructions, when executed by the one or more processors, cause the agricultural system to control the agricultural machine by controlling one or more actuators of the agricultural machine based on the probability value.

5. The agricultural system of claim 1, wherein the probability value comprises a first probability value, wherein the characteristic level category comprises a first characteristic level category, and wherein the instructions, when executed by the one or more processors, further cause the agricultural system to:
determine, based, at least, on the image, one or more additional probability values corresponding to the image, each additional probability value of the one or more additional probability values indicating a probability that the characteristic indicated by the image corresponds to a respective additional characteristic level category of the plurality of characteristic level categories, each respective additional characteristic level category different than the first characteristic level category; and
control the agricultural machine based, at least, on the first probability value and the one or more additional probability values.

6. The agricultural system of claim 5, wherein each characteristic level category of the plurality of characteristic level categories comprises a respective relationship relative to a desired characteristic level, wherein the respective relationship of the first characteristic level category is one of: (i) over the desired characteristic level; (ii) under the desired characteristic level; or (iii) matching the desired characteristic level.

7. The agricultural system of claim 1, wherein the image comprises a first image, wherein the probability value comprises a first probability value, wherein the imaging device is configured to capture a second image indicative of the characteristic, and wherein the instructions, when executed by the one or more processors, cause the agricultural system to:
determine, based, at least, on the second image, a second probability value corresponding to the second image, the second probability value indicating a probability that the characteristic indicated by the second image corresponds to the characteristic level category of the plurality of characteristic level categories;
determine an aggregated probability value based, at least, on the first probability value and the second probability value, the aggregated probability value indicating a probability that the characteristic indicated by a plurality of images, including the first image and the second image, corresponds to the characteristic level category of the plurality of characteristic level categories; and
control the agricultural machine based, at least, on the aggregated probability value.

8. An agricultural system comprising:
one or more processors; and
memory storing instructions executable by the one or more processors that, when executed by the one or more processors, cause the agricultural system to:
obtain an image, captured by an imaging device during an agricultural operation, the image indicative of a characteristic;
determine, based, at least, on the image, a plurality of probability values corresponding to the image, each probability value of the plurality of probability values indicating a respective probability that the characteristic indicated by the image corresponds to a respective characteristic level category of a plurality of characteristic level categories; and
control an agricultural machine based, at least, on the plurality of probability values.

9. The agricultural system of claim 8, wherein the characteristic comprises one of an agricultural characteristic, a machine characteristic, a performance characteristic, or a crop characteristic.

10. The agricultural system of claim 9, wherein the agricultural operation comprises a harvesting operation, wherein the agricultural machine comprises a harvester, wherein the characteristic comprises a residue performance characteristic, and wherein the instructions, when executed by the one or more processors, cause the agricultural system to control the harvester by controlling one or more actuators of a residue subsystem of the harvester based, at least, on the plurality of probability values.

11. The agricultural system of claim 8, wherein the image comprises a first image, wherein the plurality of probability values comprises a first plurality of probability values, wherein the instructions, when executed by the one or more processors, cause the agricultural system to:
obtain a second image, captured by the imaging device during the agricultural operation, the second image indicative of the characteristic;
determine, based, at least, on the second image, a second plurality of probability values corresponding to the second image, each probability value of the second plurality of probability values indicating a respective probability that the characteristic indicated by the second image corresponds to a respective characteristic level category of the plurality of characteristic level categories; and
control the agricultural machine based, at least, on the first plurality of probability values and the second plurality of probability values.

12. The agricultural system of claim 11, wherein the instructions, when executed by the one or more processors, cause the agricultural system to:
generate a plurality of aggregated probability values based, at least, on the first plurality of probability values and the second plurality of probability values, each aggregated probability value of the plurality of aggregated probability values indicating a respective probability that the characteristic indicated by a plurality of images, including the first image and the second image, corresponds to a respective characteristic level category of the plurality of characteristic level categories; and
control the agricultural machine based, at least, on the plurality of aggregated probability values.

13. The agricultural system of claim 8, wherein the plurality of probability values comprises, at least, a first probability value and a second probability value wherein the plurality of characteristic level categories comprises, at least, a first characteristic level category and a second characteristic level category, wherein the first probability value indicates a probability that the characteristic indicated by the image corresponds to the first characteristic level category, wherein the second probability values indicates a probability that the characteristic indicated by the image corresponds to the second characteristic level category, wherein the first characteristic level comprises a first relationship relative to a desired characteristic level, wherein the second characteristic level comprises a second relationship relative to the desired characteristic level, wherein first relationship and the second relationship are each a different one of: (i) over the desired characteristic level; (ii) under the desired characteristic level; or (iii) matching the desired characteristic level.

14. An agricultural system comprising:
one or more processors; and
memory storing instructions executable by the one or more processors that, when executed by the one or more processors, cause the agricultural system to:
obtain a plurality of images, captured by an at least one imaging device during an agricultural operation, each image of the plurality of images indicative of a characteristic;
determine for each image of the plurality of images based, at least, on the corresponding image, a respective set of probability values for the corresponding image, each probability value of each respective set of probability values indicating a probability that the characteristic in the corresponding image corresponds to a respective characteristic level category of a plurality of characteristic level categories; and
control an agricultural machine based, at least, on the respective sets of probability values.

15. The agricultural system of claim 14, wherein the characteristic comprises one of an agricultural characteristic, a machine characteristic, a performance characteristic, or a crop characteristic.

16. The agricultural system of claim 15, wherein the characteristic comprises a residue performance characteristic.

17. The agricultural system of claim 14, wherein each respective characteristic level category of the plurality of characteristic level categories comprises a different relationship relative to a desired characteristic level.

18. The agricultural system of claim 14, wherein the instructions, when executed by the one or more processors, further configure the agricultural system to:
generate based, at least, on the respective sets of probability values, a plurality of plots, each plot corresponding to a particular respective characteristic level category of the plurality of characteristic level categories, each plot plotting the probability value of each respective set of probability values indicating the probability that the characteristic in the corresponding image corresponds to the particular respective characteristic level corresponding to the plot; and
control an interface mechanism to present the plurality of plots.

19. The agricultural system of claim 18, wherein the instructions, when executed by the one or more processors, further configure the agricultural system to:
generate, based, at least, on the respective sets of probability values, a plot, the plot plotting the probability value of each respective set of probability values having the highest value; and
control an interface mechanism to present the plot.

20. The agricultural system of claim 19, wherein the instructions, when executed by the one or more processors, cause the agricultural system to:
generate a plurality of aggregated probability values based, at least, on the respective sets of probability values for the plurality of images, each aggregated probability value of the plurality of aggregated probability values indicating a respective probability that the characteristic indicated by the plurality of images corresponds to a respective characteristic level category of the plurality of characteristic level categories; and
control the agricultural machine based, at least, on the plurality of aggregated probability values.
